(19) United States
(12) Patent Application Publication
(10) Pub. No.: US 2020/0186990 A1
(43) Pub. Date: Jun. 11, 2020

(54) MANAGING WIRELESS COMMUNICATION BETWEEN WIRELESS COMMUNICATION DEVICE AND CELLULAR CARRIER NETWORK

(71) Applicant: XCOM Labs, Inc., San Diego, CA (US)

(72) Inventors: Paul Eric Jacobs, La Jolla, CA (US); Matthew Stuart Grob, La Jolla, CA (US); Michael Mingxi Fan, San Diego, CA (US)

(21) Appl. No.: 16/702,211

(22) Filed: Dec. 3, 2019

Related U.S. Application Data
(60) Provisional application No. 62/775,817, filed on Dec. 5, 2018.
(60) Provisional application No. 62/775,821, filed on Dec. 5, 2018.
(60) Provisional application No. 62/775,825, filed on Dec. 5, 2018.

(51) Int. Cl. H04W 8/18; H04W 76/14; H04L 9/06; H04W 12/00

(52) U.S. Cl. CPC H04W 8/18; H04W 76/14; H04L 2209/38; H04W 12/00514; H04L 9/0637

(57) ABSTRACT

Aspects of this disclosure relate to of managing wireless communication between a cellular carrier network and a wireless communication device. A request that a wireless communication device connect to the cellular carrier network via a cellular link between an anchor device and the cellular carrier network can be detected. Wireless communication of information associated with the wireless communication device between the anchor device and the cellular carrier network can be tracked. An account associated with the anchor device can be updated based on serving as an anchor device for the wireless communication device.

### CROSS REFERENCE TO PRIORITY APPLICATIONS

This application claims the benefit of priority of U.S. Provisional Patent Application No. 62/775,817, filed Dec. 5, 2018 and titled “WIRELESS COMMUNICATION DEVICE WITHOUT CELLULAR MODEM;” U.S. Provisional Patent Application No. 62/775,821, filed Dec. 5, 2018 and titled “ESTABLISHING PEER-TO-PEER LINK BASED ON SOCIAL NETWORK LIST,” and U.S. Provisional Patent Application No. 62/775,825, filed Dec. 5, 2018 and titled “TOKENS FOR CONNECTING WIRELESS COMMUNICATION DEVICE TO CELLULAR CARRIER NETWORK.” The disclosures of each of the above-mentioned applications are hereby incorporated by reference herein in their entireties and for all purposes.

### BACKGROUND

### Technical Field

Embodiments of this disclosure relate to wireless communications, related devices, and/or related networks.

### Description of Related Technology

Cellular phones and other computing devices with cellular connectivity functionality are configured to wirelessly exchange information with cellular carrier networks. Such devices typically include cellular modems and associated radio frequency circuitry to facilitate cellular communications. Some of these devices can also include non-cellular modems to facilitate non-cellular wireless communications, such as WiFi and/or Bluetooth communications.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a method of managing wireless communication between a cellular carrier network and a wireless communication device. The method includes detecting, by one or more servers, that the wireless communication device requests to connect to the cellular carrier network via a non-cellular link with an anchor device and a cellular link between the anchor device and the cellular carrier network. The wireless communication device stores cellular subscription information for the cellular carrier network and does not include any cellular modem. The method includes determining, by the one or more servers, an amount of tokens to provide to the anchor device for wirelessly exchanging information associated with the wireless communication device with the cellular carrier network. The method includes tracking wireless communication of information associated with the wireless communication device between the anchor device and the cellular carrier network. The method also includes, updating, by the one or more servers, account data for an account associated with the anchor device to increase a number of tokens for the account in response to the determining and the tracking.

The method can involve using blockchain technology. The method can further include determining that the wireless communication device does not include any cellular modem and stores the cellular subscription information. The one or more servers can include a social media server associated with a social media service.

The method can include identifying a type of data being exchanged between the wireless communication device and the cellular carrier network, wherein the amount of tokens associated with the determining is based on the identifying. The method can include identifying one or more network conditions, wherein the amount of tokens associated with the determining is based on the identifying. The updating can include providing at least a portion of a token from a social media service to the account for the anchor device. The method can include decreasing a number of tokens of an account associated with a content provider in association with the updating. The method can include decreasing a number of tokens of an account associated with an advertiser in association with the updating. The method can include decreasing a number of tokens of an account associated with the wireless communication device in association with the updating.

Another aspect of this disclosure is a system for managing wireless communication between a cellular carrier network and a wireless communication device. The system includes one or more servers comprising one or more processors and memory storing computer executable instruction. The computer-executable instructions, when executed by the one or more processors, cause the one or more servers to at least: detect that a wireless communication device requests to connect to a cellular carrier network via a non-cellular link with an anchor device and a cellular link between the anchor device and the cellular carrier network, wherein the wireless communication device stores cellular subscription information for the cellular carrier network and does not include any cellular modem; determine an amount of tokens to provide to the anchor device for wirelessly exchanging information associated with the wireless communication device with the cellular carrier network; track wireless communication of information associated with the wireless communication device between the anchor device and the cellular carrier network; and update account data for an account associated with the anchor device to increase a number of tokens for the account based on the amount of tokens and the wireless communication of information associated with the wireless communication device between the anchor device and the cellular carrier network.

The computer-executable instructions, when executed by the one or more processors, can cause the one or more servers to determine that the wireless communication device does not include any cellular modem and stores the cellular subscription information. The one or more servers can include a social media server associated with a social media service.

The computer-executable instructions, when executed by the one or more processors, can cause the one or more servers to determine the amount of tokens based on identifying a type of data being exchanged between the wireless communication device and the cellular carrier network.

The computer-executable instructions, when executed by the one or more processors, can cause the one or more servers to determine the amount of tokens based on identifying one or more network conditions.

Another aspect of this disclosure is a method of managing wireless communication between a cellular carrier network and a wireless communication device. The method includes detecting, by one or more servers, that the wireless communication device requests to connect to the cellular carrier network via a cellular link between an anchor device and the cellular carrier network. The method includes determining, by the one or more servers, an amount of tokens to provide to the anchor device for wirelessly exchanging information associated with the wireless communication device with the cellular carrier network. The method includes tracking wireless communication of information associated with the wireless communication device between the anchor device and the cellular carrier network. The method also includes updating, by the one or more servers, account data for an account associated with the anchor device to increase a number of tokens for the account in response to the determining and the tracking.

The method can involve using blockchain technology.

The tracking can be associated with the wireless communication device communicating with the anchor device through a direct link between the anchor device and the wireless communication device. The tracking can be associated with the wireless communication device communicating with the anchor device via an intermediate anchor device.

The method can include identifying a type of data being exchanged between the wireless communication device and the cellular carrier network, wherein the amount of tokens associated with the updating is based on the identifying. The method can include identifying one or more network conditions, wherein the amount of tokens associated with the updating is based on the identifying. The method can include identifying one or more characteristics of the anchor device, wherein the amount of tokens associated with the updating is based on the identifying. The method can include identifying that the wireless communication device equipment does not include a cellular modem.

Another aspect of this disclosure is a wireless communication device that includes one or more antennas; a transceiver in communication with the one or more antennas, and memory storing cellular subscription information associated with the wireless communication device. The transceiver is configured to provide information to the one or more antennas for transmission and to process information received via the one or more antennas. The wireless communication device does not include a cellular modem.

The wireless communication device can include a processor in communication with the transceiver. The processor can be configured to cause the wireless communication device to discover an anchor device available for establishing a peer-to-peer link. The processor can be configured to determine that the anchor device is associated with a user included in a social network list associated with a user of the wireless communication device.

The wireless communication device can include a processor in communication with the transceiver. The processor can be configured to cause the wireless communication device to establish a peer-to-peer link with an anchor device and to initiate a connection with a cellular carrier network via tunneling through the peer-to-peer link. The wireless communication can include a display, wherein the processor is configured to cause a cellular service logo to be presented on the display in association with the connection to the cellular carrier network via tunneling through the peer to peer link being established.

Another aspect of this disclosure is wireless communication device that includes one or more antennas, a transceiver in communication with the one or more antennas, and memory storing cellular subscription information associated with the wireless communication device. The transceiver is configured to provide information to the one or more antennas for transmission and to process information received via the one or more antennas. The wireless communication device is only configured to wirelessly transmit over one or more non-cellular links.

The wireless communication device can include a processor in communication with the transceiver. The processor can be configured to cause the user equipment to establish a peer-to-peer link with an anchor device and to initiate a connection with a cellular carrier network via tunneling through the peer-to-peer link.

Another aspect of this disclosure is a method of wireless communication that includes: establishing, by a primary wireless communication device without a cellular modem, a peer to peer link with an anchor device; transmitting, by the primary wireless communication device, cellular subscription information associated with the primary wireless communication device to the anchor device via the peer to-peer link; receiving, by the primary wireless communication device, a confirmation of authentication of the cellular subscription information via the peer-to-peer link; and receiving, by the primary wireless communication device, data provided by a base station and associated with a cellular subscription of the primary wireless communication device via the peer-to-peer link with the anchor device, wherein the anchor device has a different cellular subscription than the primary wireless communication device.

Another aspect of this disclosure is a user equipment that includes one or more antennas, a cellular modem in communication with the one or more antennas, and a processor. The processor is configured to detect that a wireless communication device stores cellular subscription information for the wireless communication device and is only configured to wirelessly transmit over one or more non-cellular links. The processor is configured to cause a wireless peer-to-peer link to be established with the wireless communication device. The processor is configured to, in response to detecting that the wireless communication device stores the cellular subscription information for the wireless communication device and is only configured to wirelessly transmit over non-cellular links, cause the cellular modem to modulate transmit data associated with the wireless communication device for transmission via the one or more antennas and to demodulate received data associated with the wireless communication device received via the one or more antennas.

The user equipment can be configured to receive the transmit data associated with the wireless communication device over the wireless peer-to-peer link. The processor can be configured to cause the demodulated received data to be transmitted to the wireless communication device over the wireless peer-to-peer link.

Another aspect of this disclosure is a method of wireless communication that includes obtaining, by a primary wireless communication device, data identifying a social network list; discovering, by the primary wireless communication device, an anchor device associated with the social network list; establishing, by the primary wireless communication device, a wireless peer-to-peer connection with the anchor device; transmitting, by the primary wireless communication device, cellular subscription information associated with the primary wireless communication device to the anchor device via the peer to-peer link; receiving, by the primary wireless communication device, a confirmation of authentication of the cellular subscription information via the peer-to-peer link; and receiving, by the primary wireless communication device, data provided by a base station and associated with a cellular subscription of the primary wireless communication device via the peer to peer link with the anchor device, wherein the anchor device has a different cellular subscription than the primary user equipment.

In some embodiments, the primary device does not include a cellular modem. The primary wireless communication device can configured to wireless transmit data only over one or more non-cellular links.

Another aspect of this disclosure is a wireless communication device that includes one or more antennas, a transceiver in communication with the one or more antennas, a memory storing cellular subscription information for the wireless communication device, and a processor in communication with the transceiver and the memory. The transceiver is configured to provide information to the one or more antennas for transmission and to process information received via the one or more antennas. The processor is configured to obtain data identifying a social network list associated with the wireless communication device; cause the wireless communication device to discover an anchor device associated with the social network list; cause the wireless communication device to establish a wireless peer-to-peer connection with the anchor device; and cause the wireless communication device to transmit the cellular subscription information for the wireless communication device via the peer-to-peer link.

In some embodiments, the wireless communication device does not include a cellular modem. The wireless communication device can be configured to wireless transmit data only over one or more non-cellular links.

The social network list can include social media connections of a user of the wireless communication device. The social network list can include social media connections of a user of the wireless communication device and additional social media connections of the social media connections.

Another aspect of this disclosure is a method of communication that includes: obtaining, by a primary wireless communication device, data identifying a social network list; discovering, by the primary wireless communication device, an anchor device associated with the social network list; establishing, by the primary wireless communication device, a wireless peer-to-peer connection with the anchor device; receiving, by the primary wireless communication device, receive data provided by a wireless access point and associated with the primary wireless communication device via the peer-to-peer link with the anchor device; and transmitting, by the primary wireless communication device, transmit data to the wireless access point and associated with the primary wireless communication device via the peer-to-peer link with the anchor device.

Another aspect of this disclosure is a method of wireless communication that includes: obtaining, by an anchor device, data identifying a social network list; determining, by the anchor device, that a wireless communication device is associated with the social network list; based on the determining, establishing a wireless peer-to-peer link between the anchor device and the wireless communication device; transmitting, by the anchor device, uplink cellular data associated with the wireless communication device to a base station; receiving, the anchor device, downlink cellular data associated with the wireless communication device from the base station; and transmitting, by the anchor device, the downlink cellular data to the wireless communication device via the wireless peer-to-peer connection.

In some embodiments, the wireless communication device does not include a cellular modem. The method can include detecting, by the anchor device, that the wireless communication device does not include a cellular modem.

Another aspect of this disclosure is method of wireless communication that includes: obtaining, by an anchor device, data identifying a social network list; determining, by the anchor device, that a wireless communication device is associated with the social network list; based on the determining, establishing a wireless peer-to-peer link between the anchor device and the wireless communication device; transmitting, by the anchor device, transmit data associated with the wireless communication device to a wireless access point; receiving, the anchor device, received data associated with the wireless communication device from the wireless access point; and transmitting, by the anchor device, the received data to the wireless communication device via the wireless peer-to-peer connection.

Another aspect of this disclosure is a method of token based management that includes: storing, by one or more servers, account data for an account associated with an anchor device, the account data including a number of tokens for the account; detecting, by the one or more servers, that a wireless communication device connects to a cellular carrier network via a peer-to-peer link with the anchor device and the anchor device, wherein the wireless communication device stores cellular subscription information and does not include a cellular modem; assigning, by the one or more servers, an amount of tokens to the anchor device associated with the peer-to-peer link with the wireless communication device; and in response to the detecting and the assigning, updating, by the one or more servers, the account data to increase the number of tokens for the account.

The one or more servers can include one or more social media servers associated with a social media service. The method can involve using blockchain technology.

The updating can include providing one or more tokens from a social media service to the account for the anchor device. The method can include decreasing a number of tokens of an account associated with a content provider in association with the updating. The method can include decreasing a number of tokens of an account associated with an advertiser in association with the updating. The method can include decreasing a number of tokens of an account associated with the wireless communication device in association with the updating.

The method can include determining a type of data being exchanged between the wireless communication device and the cellular carrier network, wherein the amount of tokens associated with the assigning is based on the determining. The method can include determining one or more network conditions, wherein the amount of tokens associated with the assigning is based on the determining. The method can include determining social media connection information associated with users of the wireless communication device and the anchor device, wherein the amount of tokens associated with the assigning is based on the determining. The method can include determining that the wireless communication device does not include a cellular modem.

The method can include determining that the wireless communication device stores the cellular subscription information

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will now be described, by way of non-limiting example, with reference to the accompanying drawings.

FIG. 1 is a diagram illustrating a wireless network environment in which a wireless communication device without a cellular modem establishes a cellular communication via a peer-to-peer (P2P) link with a nearby anchor user equipment (UE) according to an embodiment.

FIG. 2 is a block diagram of a wireless communication device without a cellular modem according to an embodiment.

FIG. 3 is flow diagram of a process of establishing a connection between a wireless communication device without a cellular modem and a cellular service provider according to an embodiment.

FIG. 4A is a diagram illustrating a wireless network environment in which a primary wireless communication device establishes a cellular communication via a P2P link with a nearby anchor UE according to an embodiment.

FIG. 4B is a diagram illustrating a wireless network environment in which a primary wireless communication device establishes a cellular communication via a plurality of anchor devices according to an embodiment.

FIG. 5 is a diagram illustrating another wireless network environment in which a primary wireless communication device establishes a cellular communication via a P2P link with a nearby anchor UE according to an embodiment.

FIG. 6 is a diagram illustrating a communication environment in which a social network list can be used to discover a UE for P2P communication according to an embodiment.

FIG. 7 is a diagram illustrating another communication environment in which a social network list can be used to discover a UE for P2P communication according to an embodiment.

FIG. 8 is a diagram illustrating another communication environment in which a social network list can be used to discover a UE for P2P communication according to an embodiment.

FIG. 9 is a diagram illustrating another communication environment in which a social network list can be used to discover a UE for P2P communication according to an embodiment.

FIG. 10 illustrates an example primary wireless communication device with a user interface presenting a tab for requesting a peer-to-peer connection with an anchor user equipment associated with a social network list according to an embodiment.

FIG. 11 illustrates an example anchor user equipment with a user interface presenting a tab for accepting a peer-to-peer connection request from a primary wireless communication device associated with a social network list according to an embodiment.

FIG. 12 is a diagram illustrating a communication environment in which a social media service can manage tokens associated with an anchor user equipment serving as an anchor device for a primary wireless communication device according to an embodiment.

FIG. 13 is a diagram illustrating a communication environment in which one or more token servers can manage tokens associated with an anchor user equipment serving as an anchor device for a primary wireless communication device according to an embodiment.

FIG. 14A is a diagram illustrating a communication environment in which one or more token servers can manage tokens associated with an anchor user equipment serving as an anchor device for a primary wireless communication device according to an embodiment.

FIG. 14B is a diagram illustrating a communication environment in which one or more token servers can manage tokens associated with an anchor user equipment serving as an anchor device for a primary wireless communication device in a multi-hop case according to an embodiment.

FIG. 15 is a block diagram of a token server.

FIG. 16 is a flow diagram of a method of wireless communication between a cellular carrier network and a wireless communication device according to an embodiment.

FIG. 17 is a flow diagram of a method of facilitating wireless communication between a wireless communication device and a cellular carrier network according to an embodiment.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings. The headings provided herein are for convenience only and do not necessarily affect the scope or meaning of the claims.

In this disclosure, a wireless communication device without a cellular modem that stores cellular subscription information is provided. The wireless communication device can provide the cellular subscription information to a cellular carrier network via an anchor device that includes a cellular modem. The anchor device can exchange information associated with the wireless communication device with the cellular carrier network via a cellular link. The anchor device can also exchange information with the wireless communication device via a non-cellular link.

Discovering and authorizing devices for peer-to-peer connection based on social network connections are disclosed. Based on a social media list, a wireless communication device can request a peer-to-peer connection with an anchor device. The anchor device can broadcast its availability as an anchor device to other devices based on a social network list. The anchor device can determine whether to authorize a peer-to-peer connection with another wireless communication device based on the social network list.

Methods and systems are disclosed for managing wireless communication between a wireless communication device and a cellular carrier network. Tokens can provided to an account associated with an anchor device for serving as an anchor between the wireless communication device and the cellular carrier network. An amount of tokens for serving as an anchor device can be determined by on one or more of a variety of factors. Usage as an anchor device can be tracked. Then tokens can be provided for serving as the anchor device. This can enable more wireless communication devices to connect to a cellular carrier network and/or enhance cellular connection service.

Wireless Communication Device without Cellular Modem

The cost of certain cellular phones today is lower bounded by the cost of a cellular modem and associated radio frequency (RF) circuitry. The cost of a cellular wireless communication device could be significantly reduced without the cellular modem and associated radio frequency (RF) circuitry. For example, with only a lower cost connectivity module such as a Wi-Fi module, a Bluetooth (BT) module, or a module of any other suitable lower cost alternative technology, the device could be less expensive than a similar device that includes a cellular module. At the same time, it is desirable for a wireless communication device without a cellular modem to be served by a cellular network operator via a cellular subscription. The cellular subscription can enable service maintenance, tracking, and quality of service by the cellular network operator.

Aspects of this disclosure relate to a low cost wireless communication device with a cellular subscription and without a cellular modem. The low cost wireless communication device can connect to a cellular carrier network though a peer-to-peer (P2P) link with an anchor device that includes a cellular modem. The low cost wireless communication device can include a mobile client that enables the low cost wireless communication device to discover one or more anchor devices in proximity and to establish cellular authentication over a P2P link. The low cost wireless communication device can establish an authenticated connection with the cellular carrier network via a traffic tunnel through the anchor device. The connection can be established with existing cellular offload architecture via network elements, such as an Evolved Packet Data Gateway (ePDG). In certain embodiments, the mobile client can enable the use of social network services to establish a cellular connection via P2P links to a nearby anchor device. The mobile client can enable the anchor device to be incentivized to establish the data tunnel for low-cost device. Accordingly, low cost wireless communication devices without a cellular modem and with capabilities of receiving cellular operator serviced data from and sending data to a cellular network operator are disclosed. With the low cost wireless communication devices disclosed herein, cellular network services can be extended to inexpensive devices and/or devices without a cellular modem.

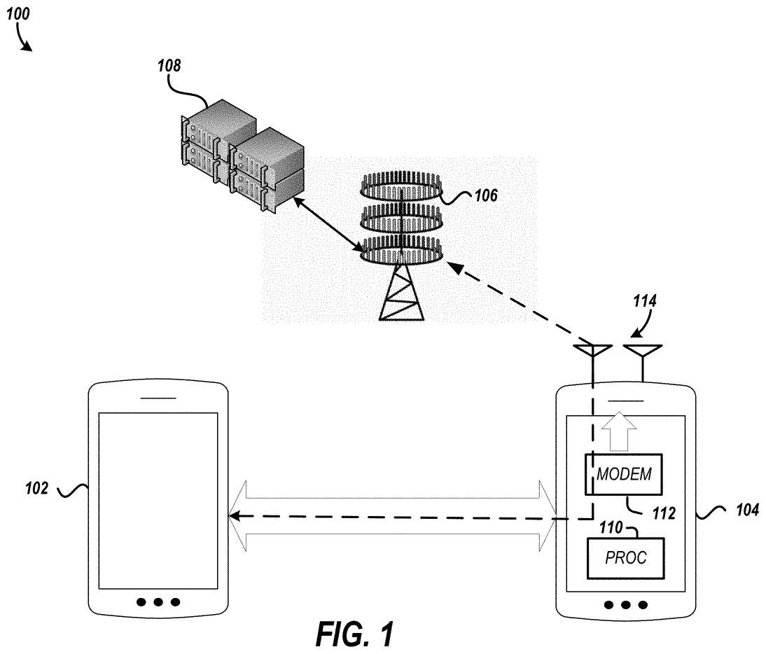

FIG. 1 is a diagram illustrating a wireless network environment 100 in which a primary wireless communication device 102 establishes a cellular communication via a peer-to-peer (P2P) link with a nearby anchor user equipment (UE) 104. The cellular communication can include a phone call. Alternatively or additionally, the cellular communication can include any other suitable data exchange. The primary wireless communication device 102 does not include a cellular modem. The primary wireless communication device 102 is only configured to wirelessly exchange information over a non-cellular link.

As illustrated, the primary wireless communication device 102 can wirelessly exchange information over a P2P link. The P2P link can be established with Bluetooth, WiFi, or any other suitable non-cellular P2P technology. The anchor UE 104 includes a cellular modem. The anchor UE 104 can wirelessly transmit cellular data associated with the primary wireless communication device 102 via one or more antennas to a base station 106. The anchor UE 104 can wirelessly receive cellular data associated with the primary wireless communication device 102 from the base station 106 via one or more antennas of the anchor UE 104. In FIG. 1, information flow between the primary wireless communication device 102 and the base station 106 is shown with dashed lines.

The anchor UE 104 can broadcast its availability as an anchor device though which a primary wireless communication device 102 can connect to a cellular service provider. The primary wireless communication device 102 can discover the anchor UE 104. In certain embodiments, the anchor UE 104 can enable primary UEs and/or other primary wireless communication devices associated with a social network graph and/or an operator assigned list to connect to the cellular service provider via the anchor UE 104.

The primary wireless communication device 102 can include a cellular subscription module storing cellular subscription information associated with the primary wireless communication device 102. Accordingly, the primary wireless communication device 102 can maintain its own cellular credential. The cellular subscription information can identify one or more of a unique phone number associated with the primary wireless communication device 102, another unique identifier of the primary wireless communication device 102, an account associated with the primary wireless communication device 102, a particular user or group of users associated with the primary wireless communication device 102, etc. In certain instances, the cellular subscription information can indicate that the primary wireless communication device 102 is not configured to wirelessly transmit information over a cellular link.

In some instances, the anchor UE 104 can include a processor 110 configured to detect that the primary wireless communication device 102 stores cellular subscription information for the primary wireless communication device 102 and is only configured to wirelessly transmit over non-cellular links. The processor 110 of the anchor UE 104 can determine that the primary wireless communication device 102 stores cellular subscription information and does not include a cellular modem based on any suitable information provided by the primary wireless communication device 102. The processor 110 can be a baseband processor. Although illustrated as being separate in FIG. 1, in some instances, the processor 110 can implement the modem 112 or a subset of features of the modem.

The anchor UE 104 can take action in response to detecting that the primary wireless communication device 102 stores cellular subscription information and does not include a cellular modem. For example, the action can include establishing a peer-to-peer link with the primary wireless communication device 102. Alternatively or additionally, the action can include using a cellular modem 112 of the anchor UE 104 to modulate transmit data associated with the primary wireless communication device 102 for transmission to the base station 106 via the one or more antennas 114 of the anchor UE 104. In at least some such cases, the action can also include using its cellular modem 112 to demodulate received data associated with the primary wireless communication device 102 that is received from the base station 106 via the one or more antennas 114 of the anchor UE 104.

In the wireless network environment 100, cellular connectivity can be established via an ePDG and/or one or more other cellular offload mechanisms. The anchor UE 104 can receive incentives for its assistance with routing data associated with the primary wireless communication device 102 between the primary wireless communication device 102 and the cellular carrier network.

Although FIG. 1 is described with reference to an anchor UE 104 for illustrative purposes, any suitable anchor wireless communication device can be implemented. The anchor wireless communication device can be referred to as a gateway wireless communication device is certain instances. Example anchor wireless communication devices include, but are not limited to, a mobile phone, a mobile computing device, a wearable computing device such as a smart watch or an ear piece or smart glasses, a networked appliance (e.g., a consumer networked appliance or industrial plant equipment), an industrial robot with connectivity, a camera, a speaker, a vehicle, a vehicular communications system, a dongle, a MiFi device, a customer-premises equipment (CPE) device, or the like. In some implementations, an anchor wireless communication device can be a sensor or other networked device configured to collect data and wirelessly provide the data to another device (e.g., server), which can be connected to a core network such as the Internet. Accordingly, an anchor wireless communication device can be an Internet of Things (IoT) device in certain applications. Any of the example anchor devices can perform any suitable anchor device functionality disclosed herein.

A variety of wireless communication devices can be implemented without a cellular modem. Such wireless communication devices can include any suitable wireless communication device used by a user such as a mobile phone, a mobile computing device, a wearable computing device such as a smart watch or an ear piece or smart glasses, a networked appliance (e.g., a consumer networked appliance or industrial plant equipment), an industrial robot with connectivity, a camera, a speaker, a vehicle, or the like. In some implementations, a wireless communication device without a cellular modem can be a sensor or other networked device configured to collect data and wirelessly provide the data to another device (e.g., server), which can be connected to a core network such as the Internet. Accordingly, a wireless communication devices without a cellular modem can be an IoT device in certain applications. A downlink (DL) transmission generally refers to a communication from a node to a wireless communication device. An uplink (UL) transmission generally refers to a communication from the wireless communication device to the node.

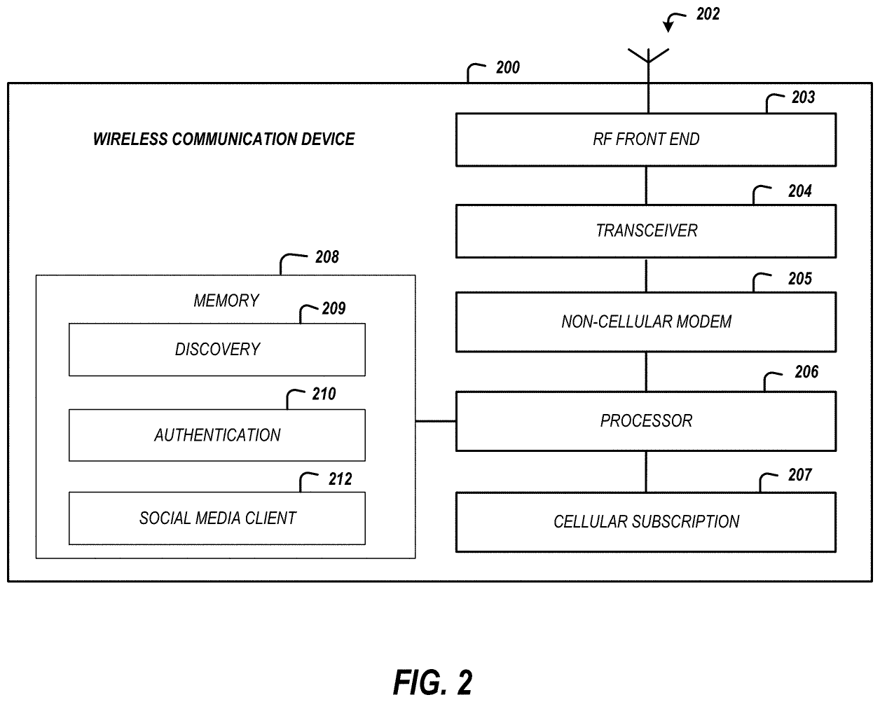

FIG. 2 is a block diagram of a wireless communication device 200 without a cellular modem according to an embodiment. The wireless communication device 200 is an example of the primary wireless communication device 102 of FIG. 1. The wireless communication device 200 does not include a cellular modem and is only configured to wirelessly transmit and receive information via non-cellular links. The wireless communication device 200 includes a non-cellular module. Such a module can be lower cost than a cellular module. The non-cellular module can be a Bluetooth module, a wireless local area network (WLAN) module, or any other suitable non-cellular wireless communication module. Such a module can include a non-cellular modem, a transceiver, and an RF front end. In some instances, a non-cellular module can include an integrated antenna.

As illustrated, the wireless communication device 200 includes an antenna 202, an RF front end 203, a transceiver 204, a non-cellular modem 205, a processor 206, a cellular subscription module 207, and a memory 208. Accordingly, even though the wireless communication device 200 is not configured to wirelessly exchange data via a cellular link, the wireless communication device 200 includes a cellular subscription module 207. The cellular subscription module 207 can be a subscriber identification module (SIM) or SIM card, for example. In some instances, the cellular subscription module 207 can be implemented at least partly in the memory 208.

The non-cellular modem 205 can be a wireless local area network (WLAN) modem configured to modulate and demodulate signals in accordance with a WLAN standard, such as WiFi. The non-cellular modem 205 can be a wireless personal area network (WPAN) modem configured to modulate and demodulate signals in accordance with a WPAN standard, such as Bluetooth or ZigBee. In certain instances, some or all of the functionality of the non-cellular modem 205 can be implemented by the processor 206. The processor 206 can be a baseband processor.

With the non-cellular modem 205, the transceiver 204, and the RF front end 203, the wireless communication device 200 can send non-cellular wireless signals to the antenna 202. With the non-cellular modem 205, the transceiver 204, and the RF front end 203, the wireless communication device 200 can receive non-cellular wireless signals from the antenna 202. Although one antenna 202 is illustrated in FIG. 2, the wireless communication device 200 can include two or more antennas in certain instances. The antenna 202 can transmit and receive non-cellular wireless signals. The non-cellular wireless signals can be in accordance with a WLAN standard or a WPAN standard, for example. The non-cellular wireless signals can have a shorter signal range than cellular signals. In some instances, the non-cellular wireless signals can have a range of about 300 feet or less. The non-cellular wireless signals can have a range of about 150 feet or less in certain applications. The non-cellular wireless signals can have a range of about 35 feet or less in various applications.

The memory 208 can store a discovery block 209 and an authentication block 210. A mobile client can include the discovery block 209 and the authentication block 210. In some instances, the mobile client can store and/or manage cellular subscription information for the wireless communication device 200. The discovery block 209 can include instructions that, when executed by the processor 206, cause the wireless communication device 200 to discover one or more anchor devices. The authentication block 210 can include instructions that, when executed by the processor 206, cause the wireless communication device 200 to authenticate the cellular subscription information through the anchor device and tunnel traffic through the anchor device. The memory 208 can store a social media client 212. The discovery block 209 and/or the authentication block 210 can be integrated with the social network client 212. For instance, the discovery block 209 and/or the authentication block 210 can be included in the social media client 212.

A wireless communication device with a cellular subscription module and without a cellular modem can be used in a variety of useful ways. For example, a digital camera can include a WiFi module configured to transmit and receive WiFi signals and cellular subscription module but no cellular communication capability. The digital camera can connect to a cellular service provider via a P2P connection with an anchor device that includes a cellular modem. This can enable a variety of advantageous features. For instance, the digital camera can connect to the cellular network via an anchor device and be automatically configured to work without user input. Such a digital camera could be ready for use without user setup. Functionality similar to the example digital camera can be implemented with a variety of other low cost wireless communication devices, such as a WiFi and/or Bluetooth only user phone.

Anchor devices can permit access to primary wireless communication devices based on a variety of factors. In certain instances, an anchor device can permit access to wireless communication devices associated with a social network connections of a user of the anchor UE. For example, an anchor UE can broadcast its availability as an anchor UE to UEs associated with social network connections of the user of the anchor UE. As another example, an anchor UE can broadcast its availability as an anchor UE to wireless communication devices associated with social network graph (e.g., including first level social network connections, including first and second level social network connections, etc.) associated with the user of the anchor UE. To implement permission based access to the anchor UE based on social networks connections and/or a social network graph, a mobile client on the anchor UE can have access to and/or be integrated with a social network client.

Primary wireless communication devices with a cellular subscription module and without a cellular modem can request access to anchor UEs based on a variety of factors. In certain instances, a primary wireless communication devices can request access to one or more UEs associated with social network connections of a user of the primary wireless communication devices. To implement P2P requests to anchor UEs based on social network connections and/or a social network graph, a mobile client on the primary wireless communication devices can have access to and/or be integrated with a social network client. In certain applications, a primary wireless communication device can store an identifier of an anchor UE associated with a social network connection and/or one or more other associations in memory of the primary wireless communication device. This data stored in memory of the primary wireless communication device can be used to trigger discovery of the anchor UE.

A P2P link can be established between the primary wireless communication device and the anchor UE. Then the primary wireless communication device can communicate with a cellular carrier network through tunneling via the anchor UE. The primary wireless communication device can display a cellular service logo in association with a tunnel to the cellular carrier network via the anchor UE being established. The cellular service logo can indicate a Long Term Evolution (LTE) or a fifth generation (5G) connection, for example. Accordingly, a cellular service logo can be displayed on a wireless communication device without a cellular modem.

Establishing a P2P connection between two devices based on a social network connection list and/or a social network graph can be implemented between two UEs that each include cellular modems. One of the two UEs can then connect to a network of a cellular service provider via the other of the two UEs.

Tokens and/or other incentives can be provided to the UE that serves as an anchor UE. In certain applications, a UE can receive a credit for serving as the anchor UE from the primary wireless communication device and/or from the cellular network operator. Alternatively or additionally, a UE can receive a credit for serving as the anchor UE from a content provider and/or an advertiser. Tokens can be provided to the anchor UE for a in a variety of different ways.

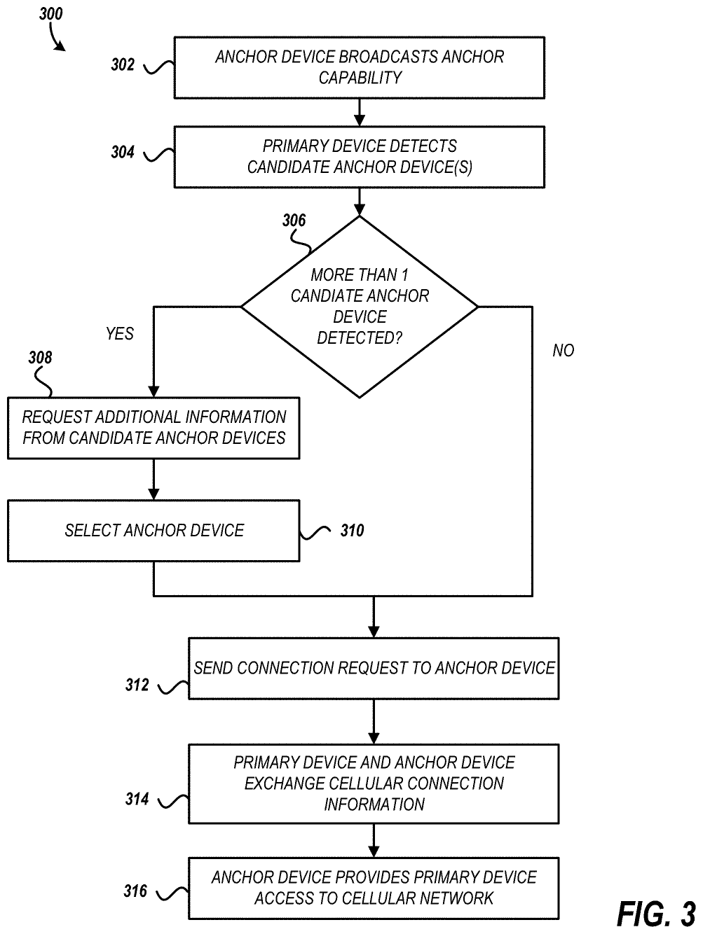

FIG. 3 is flow diagram of a process 300 of establishing a connection between a primary wireless communication device without a cellular modem and a cellular service provider according to an embodiment. The primary wireless communication device can be implemented in accordance with any suitable principles and advantages of the primary wireless communication device 102 of FIG. 1 and/or the wireless communication device 200 of FIG. 2. At block 302, an anchor UE broadcasts its capability as an anchor UE. Although the process 300 and/or may be described with reference to an anchor UE for illustrative purposes, any suitable features of the process 300 described with reference to an anchor UE can be performed with any suitable anchor device. The anchor UE can broadcast to other wireless communication devices associated with a social network list and/or graph associated with a user of the anchor UE. This can involve associating and/or identifying a social network list or graph associated with the user of the anchor UE. The broadcast can be to wireless communication devices associated with other uses on a selected friend list of the user of the anchor UE.

The primary wireless communication device can detect one or more candidate anchor UEs at block 304. The detection of the candidate anchor UE(s) can be performed via P2P connectivity of the primary wireless communication device.

Whether there is more than one candidate anchor UE can be determined at block 306. If it is determined that there is more than one candidate anchor UE at block 306, the primary wireless communication device can request additional information from some or all of the candidate anchor UEs at block 308. The additional information can include wireless area network (WAN) connectivity link quality, battery availability, and/or any other suitable information that could help to determine connection quality. At block 310, the primary wireless communication device can select an anchor UE from the candidate anchor UEs. For example, the primary wireless communication device can select the candidate anchor UE with the highest determined connection quality. After the anchor UE is selected, the primary wireless communication device can send a connection request to the selected anchor UE at block 312. Alternatively, if it is determined that there is only 1 candidate anchor UE at block 306, a connection request can be sent by the primary wireless communication device to that anchor UE at block 312.

The primary wireless communication device and the anchor UE can exchange cellular connection information at block 314. This can involve negotiating and/or agreeing on incentives through a P2P link. Alternatively or additionally, the exchange of cellular connection information can involve implementing one or more policies set by a network. Then at block 316, the anchor UE can provide the primary wireless communication device with the access to cellular network to initiate authentication.

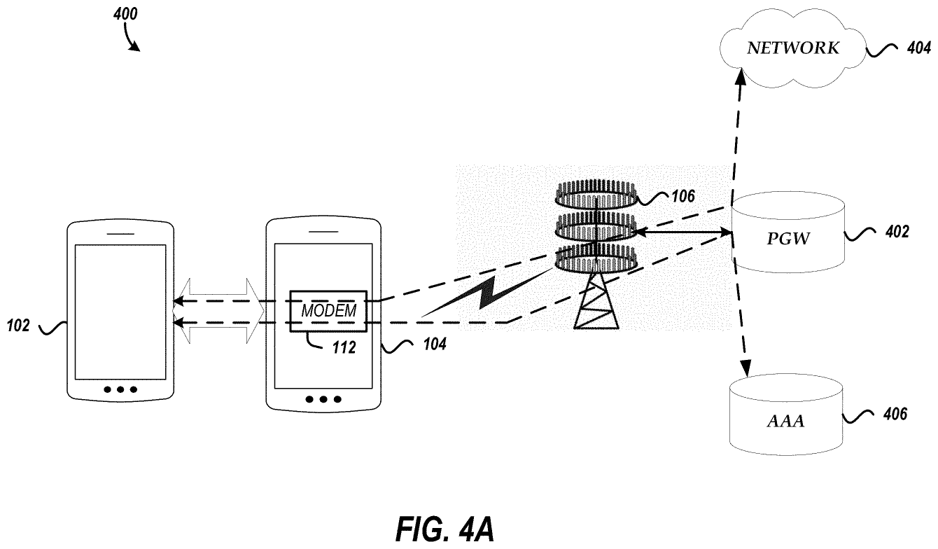

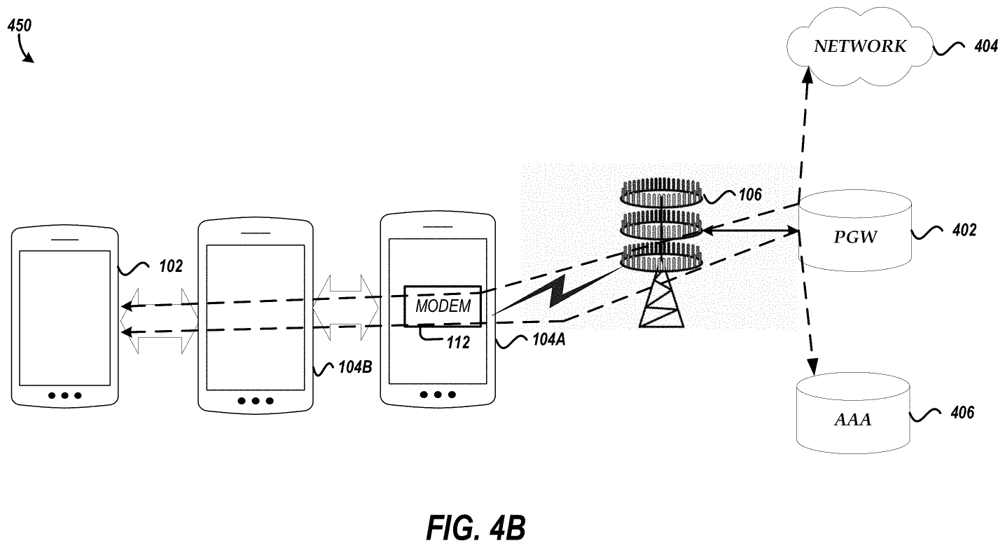

FIG. 4A is a diagram illustrating a wireless network environment 400 in which a primary wireless communication device 102 establishes a cellular communication via a P2P link with a nearby anchor UE 104. As illustrated, the wireless network environment 400 includes the primary wireless communication device 102, the anchor UE 104, a base station 106, a Packet Data Gateway (PGW) 402, a network 404 (e.g., the Internet), and an authentication, authorization, and accounting (AAA) server 406. Example connections procedures will be discussed with reference to FIG. 4A. Dashed lines illustrate the flow of information in FIG. 4A.

After discovery and establishing a P2P connection with the anchor UE 104, the primary wireless communication device 102 initiates an authentication sequence using cellular credentials associated with the primary wireless communication device 102. For example, an Extensible Authentication Protocol (EAP) using a SIM can be used for authentication. As another example, an EAP method based on authentication and key agreement (AKA) can be used for authentication.

An authentication request can be initiated by the primary wireless communication device 102. The authentication request can be transmitted to the anchor UE 104 via the P2P link. The anchor UE 104 can transmit the authentication request to the PGW 402 via the base station 106. The PGW 402 can then provide the authentication request to the AAA server 406.

In response to a successful authentication, the primary wireless communication device 102 can initiate a Dynamic Host Configuration Protocol (DHCP) sequence by sending a discover message. The anchor UE 104 can receive this request and in turn initiate a tunnel with the PGW 402. In certain applications, the tunnel can be a GPRS Tunneling Protocol (GTP) tunnel defined by 3rd Generation Partnership Project (3GPP) standards to carry General Packet Radio Service (GPRS). The tunnel can be a Proxy Mobile Internet Protocol (PMIP) tunnel in some other applications. With the tunnel, the PGW 402 can provide an Internet Protocol (IP) address to the anchor UE 104. The anchor UE 104 can in turn offer the IP address to the primary wireless communication device 102 via a P2P connection (e.g., a WiFi connection). In response to receiving the IP address, the primary wireless communication device 102 can reply back with a DHCP acknowledgement. The primary wireless communication device 102 can then start running IP traffic to the anchor UE 104 via the P2P connection.

FIG. 4B is a diagram illustrating a wireless network environment 450 in which a primary wireless communication device 102 establishes a cellular communication with a cellular carrier network via a plurality of anchor devices 104A and 104B according to an embodiment. FIG. 4B illustrates that the primary wireless communication device 102 can communicate with the base station 106 via multiple anchor devices 104A and 104B. The multiple anchor devices 104A and 104B can serve as relays.

The primary wireless communication device 102 can wirelessly communicate with an intermediate anchor device 104B via a non-cellular link. The intermediate anchor device 104B can wirelessly communicate with the anchor device 104A via a non-cellular link in certain instances. The intermediate anchor device 104B can wirelessly communicate with the anchor device 104A via a cellular link in some other instances. The intermediate anchor device 104B can include a cellular modem in some instances. Although one anchor device 104B is shown in FIG. 4B, two or more intermediate anchor devices with links in serial and/or parallel can wirelessly exchange information between the primary wireless communication device 102 and the anchor device 104A.

The primary wireless communication device 102 connecting via an anchor device 104A and one or more intermediate anchor devices 104B can be referred to as a multi-hop communication. Any suitable principles and advantages disclosed herein described with reference to a primary wireless communication device communicating with a network via a single anchor device can be applied to applications where the primary wireless communication device communicates with a network via one or more intermediate anchor devices and an anchor device.

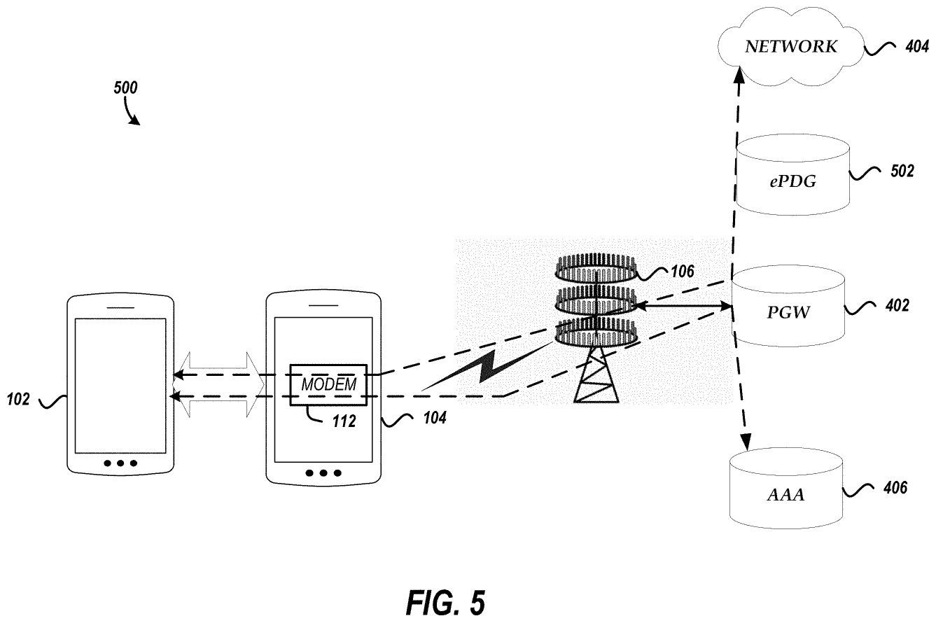

FIG. 5 is a diagram illustrating another wireless network environment 500 in which a primary wireless communication device 102 establishes a cellular communication via a P2P link with a nearby anchor UE 104. As illustrated, the wireless network environment 500 includes the primary wireless communication device 102, the anchor UE 104, a base station 106, a PGW 402, an ePDG 502, the network 404 (e.g., the Internet), and an AAA server 406. The wireless network 500 is like the wireless network 400 of FIG. 4A except that the ePDG 502 is included. As illustrated, the ePDG 502 is connected between the PGW 402 and the network 404. Example connections procedures will be discussed with reference to FIG. 5.

After discovery and establishing a P2P connection with the anchor UE 104, the primary wireless communication device 102 initiates an authentication sequence using cellular credentials. For example, an EAP using a SIM and/or an EAP-AKA can be used for authentication.

The primary wireless communication device 102 can have a WLAN IP assigned as an I-WLAN client. The I-WLAN client can open an Internet Protocol Security (IPsec) tunnel towards the PDG 402 through the anchor UE 104. The request includes the wireless Access Point Name (W-APN) identifying the PGW 402. The Packet Data Gateway (PDG) IP for the tunnel can be assigned for WLAN communication through the anchor UE 104. Data can then flow from the primary wireless communication device 102 to the anchor UE 104.

Using Social Network List to Discover and/or Authorize Devices for Peer-To-Peer Connection

Certain users may be willing to allow friends and/or other contacts to connect to a cellular network via their devices. Social network lists can be used to discover wireless communication devices for peer-to-peer connection. A primary wireless communication device can request a peer-to-peer connection with an anchor device based on a social network list. An anchor device can broadcast its availability as an anchor device to other wireless communication devices based on a social network list. An anchor device can determine whether to authorize a P2P connection with another wireless communication device based on a social network list. A social network list can include a list of social network connections, a subset of social network connections, a group including first level social network connections and second level social network connections, or a group includes first to third level social network connections. The social network list can be associated with a particular social media service in certain instances. The social network list can be associated with two or more social media services in some applications. Various examples of using social network lists in discovering another wireless communication device for wireless peer-to-peer connection are provided. Any suitable principles and advantages of these examples can be implemented with each other.

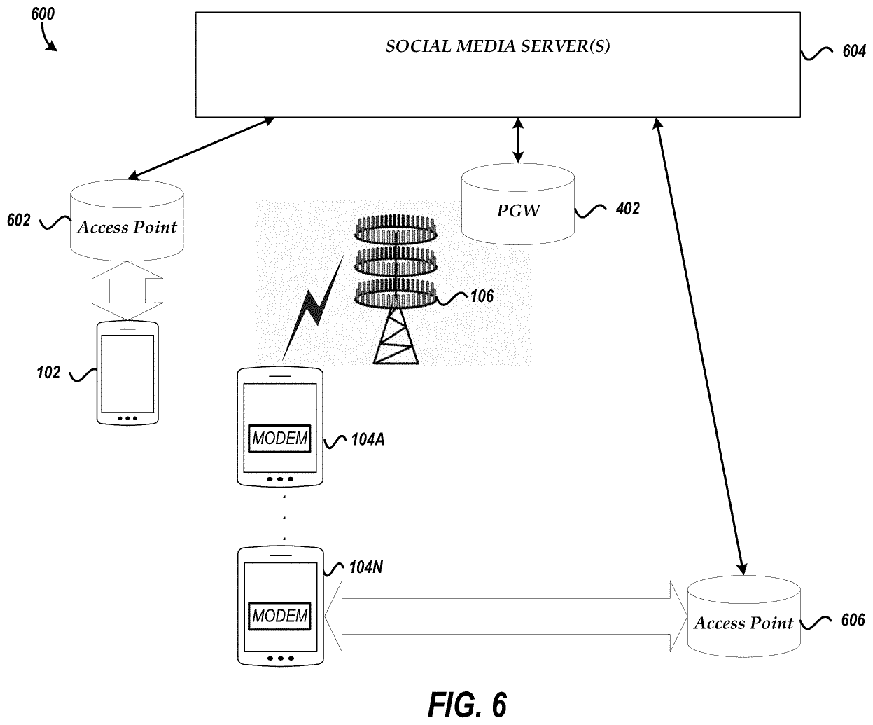

In embodiments discussed with reference to FIGS. 6 to 11, a primary wireless communication device may be described for illustrative purposes. Any suitable principles and advantages disclosed with reference to any of FIGS. 6 to 11 can be applied to a primary wireless communication device without a cellular modem. Any suitable principles and advantages disclosed with reference to any of FIGS. 6 to 11 can be applied to a primary wireless communication device without a cellular modem in applications in which the primary wireless communication device establishes a P2P link with an anchor device through which the primary wireless communication device can connect to a cellular carrier network. In embodiments discussed with reference to FIGS. 6 to 11, an anchor UE communication device may be described for illustrative purposes. Any suitable principles and advantages disclosed with reference to any of FIGS. 6 to 11 can be applied to any suitable anchor device.

FIG. 6 is a diagram illustrating a communication environment 600 in which a social network list can be used to discover a UE for P2P communication. In the communication environment 600, there are a number of ways to use a social network list in discovery of another UE for P2P wireless communication. One or more of these ways can be implemented in various applications. A primary wireless communication device can obtain data associated with a social network list and discover an anchor UE for establishing a P2P connection based on the data associated with social network list. In certain instances, based on data associated with a social network list, an anchor UE can broadcast its availability to a primary wireless communication device for a P2P connection and/or initiate a pairing with a primary wireless communication device for a P2P connection. One or more social media servers can identify a pairing of a primary wireless communication device and a secondary UE and cause the primary wireless communication device and the anchor UE to establish a wireless P2P link in certain applications. Once a wireless P2P link is established between the primary wireless communication device and the anchor UE, the primary wireless communication device can communicate with a base station via the P2P link and the anchor device. Alternatively or additionally, a wireless P2P link can enable the primary wireless communication device to communicate with a wireless access point (WAP) via the P2P link and the anchor device. FIG. 6 illustrates a state before a P2P link between a primary wireless communication device 102 and an anchor UE 104 is established. Accordingly, the UEs 104A and 104N are candidate anchor UEs in FIG. 6.

A primary wireless communication device 102 can initiate a P2P connection with an anchor UE 104A and/or 104N based on a social network list associated with a user of the primary wireless communication device 102. The primary wireless communication device 102 can obtain and store data associated with a social network list. The data can include one or more of location information of one or more UEs associated with the social network list, status of one or more users of the social network list, one or more device characteristics of one or more UEs associated with the social network list, or the like. The data can be obtained periodically, in response to one or more events (e.g., powering up the primary wireless communication device 102, discovering an available WiFi access point, or user input requesting to connect to a cellular network via an anchor device), etc. In the communication environment 600, the primary wireless communication device 102 can obtain the list from one or more social media servers 604 via a WiFi access point 602. Any other suitable wireless access point can be implemented in place of the WiFi access point 602.

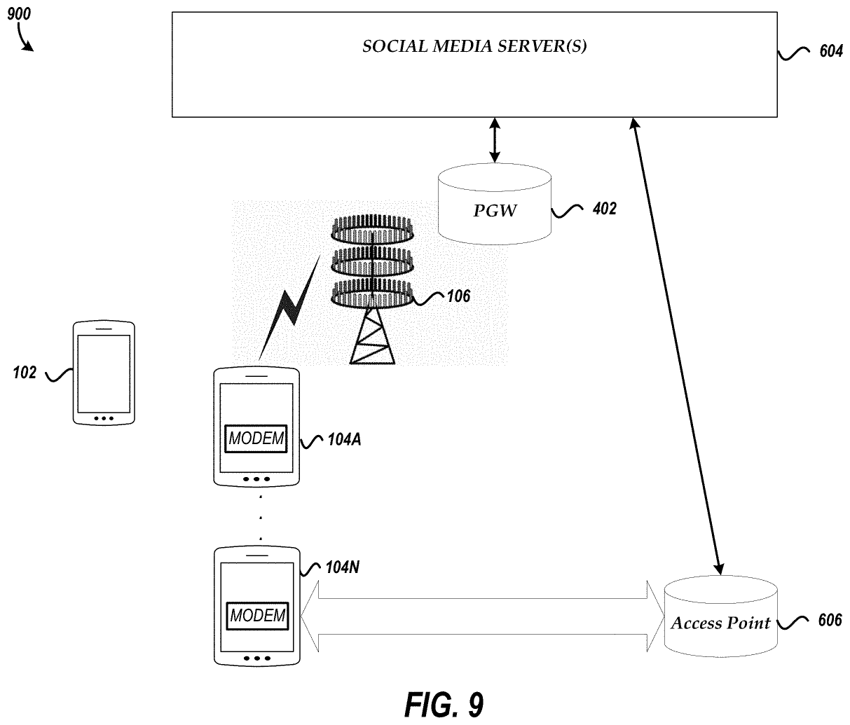

In some other communication environments, such as the communication environment shown in FIG. 9, the primary wireless communication device 102 is not connected to a wireless access point. In such cases, the primary wireless communication device 102 can store social network list data from one or more of a prior connection though an anchor UE, from installation of a social media client (e.g., the social media client 212 of FIG. 2) on the primary wireless communication device 102, from user input, or any other suitable way. The previously stored social network list data can be used at a later time for discovery of an anchor UE. As one example, the primary wireless communication device 102 can connect to a cellular carrier network through any anchor UE, which is not necessarily associated with a social network list of a user of the primary wireless communication device, and download the social network list data. Then the stored social network list data can be used to discover an anchor UE associated with the social network list for a P2P connection.

The primary wireless communication device 102 can discover one or more anchor UEs 104A to 104N associated with the social network list. This can involve a processor of the primary wireless communication device 102 identifying that an anchor UE 104 is associated with the social network list and/or that the anchor UE 104 is available as an anchor. In some instances, the primary wireless communication device 102 can prioritize and/or only search for anchor UEs associated with the social network list. After one or more candidate anchor devices are detected, the primary wireless communication device 102 can perform any suitable operations disclosed in connection with any of FIGS. 3 to 5. Alternatively or additionally, a wireless P2P link can enable the primary wireless communication device to communicate with a wireless access point via the P2P link and the anchor device.

An anchor UE 104A and/or 104N can determine whether to accept a request from the primary wireless communication device 102 to establish a P2P link based on social network list data stored by the anchor UE 104A and/or 104N. The anchor UE 104 can determine that the primary wireless communication device 102 is associated with the social network list data stored by the anchor UE 104 (e.g., that a user of the primary wireless communication device 102 is a social network connection with a user of the anchor UE 104). Then the anchor UE 104 can establish a P2P link with the primary wireless communication device 102 based on the determination.

An anchor UE can determine whether to accept a P2P connection request from a primary wireless communication device based on social network list data and other data. The other data can include any suitable data from which to decide whether to establish a P2P link with another UE. For example, the other data can include one or more of a condition of the anchor UE (e.g., battery life or usage of the anchor UE), level of friend or connection of the user of the primary wireless communication device, type of data (e.g., call data or streaming video data) to exchange with a cellular carrier network via a P2P link and the anchor UE, or the like.

A first anchor UE 104A can broadcast its availability for a P2P connection and/or initiate a P2P connection based on a social network list. The anchor UE 104A can obtain and store data associated with a social network list associated with the anchor UE 104A. The data can include one or more of location information of one or more UEs associated with the social network list, status of one or more users of the social network list, one or more device characteristics of one or more UEs associated with the social network list, or the like. The data can be obtained periodically, in response to one or more events (e.g., powering up the anchor UE 104A, establishing a link with the base station 106, or user input associated with serving as an anchor device), etc. In the communication environment 600, the anchor UE 104A can obtain the list from one or more social media servers 604 via the base station 106 and the PGW 402.

The anchor UE 104A can broadcast its availability to serve as an anchor device for one or more UEs associated with the social network list. This can involve a sending a beacon. A processor of the anchor UE 104A can identify that another UE, such as the primary wireless communication device 102, is associated with the social network list. In some instances, the anchor UE 104A can only broadcast its availability as an anchor device to other UEs associated with the social network list. After the anchor UE 104A broadcasts its availability to serve as an anchor device, the anchor UE 104A can perform any suitable operations of an anchor UE disclosed in connection with any of FIGS. 3 to 5. Alternatively or additionally, a wireless P2P link can enable the primary wireless communication device to communicate with a wireless access point via the P2P link and the anchor device.

A second anchor UE 104N can broadcast its availability for a P2P connection and/or initiate a P2P connection with the primary wireless communication device 102. As shown in FIG. 6, the second anchor UE 104N can communicate with one or more social network servers 604 via an access point 606 (e.g., a WiFi access point or any other suitable wireless access point). Otherwise, the second anchor UE 104N can initiate a P2P link with the primary wireless communication device 102 and serve as an anchor device for the primary wireless communication device 102 similarly to the first anchor UE 104A. Various anchor UEs can communicate with the social media server(s) 604 via either a cellular network or via a wireless access point.

In some instances, one or more social media servers 604 can identify that the primary wireless communication device 102 and an anchor UE 104A or 104N are candidates to establish a P2P link based on a social network list stored by the one or more social media servers 604. This can involve detecting that users of the primary wireless communication device 102 and the anchor UE 104 are social network connections (e.g., primary connections or secondary connections). The one or more social media servers 604 can detect that the primary wireless communication device 102 and the anchor UE 104 are in proximity to each other, for example, using location services.

The one or more social media servers 604 can send an instruction to an anchor UE 104 to initiate a P2P link with the primary wireless communication device 102. In some instances, the one or more social media servers 604 can send instructions to the primary wireless communication device 102 to initiate a P2P link with an anchor UE 104, for example, via a WiFi access point 602. The one or more social media servers 604 can send an instruction to both a primary wireless communication device 102 and an anchor UE 104 to initiate a P2P link with each other in certain applications.

Establishing a P2P link between the primary wireless communication device 102 and an anchor UE 104A or 104N based on data associated with a social network list can enable the primary wireless communication device storing cellular subscription information and without a cellular modem to connect to a cellular carrier network via the P2P link and the anchor UE 104A or 104N. In such instances, the primary wireless communication device 102 can be implemented, for example, in accordance with any suitable principles and advantages disclosed with reference to FIG. 2.

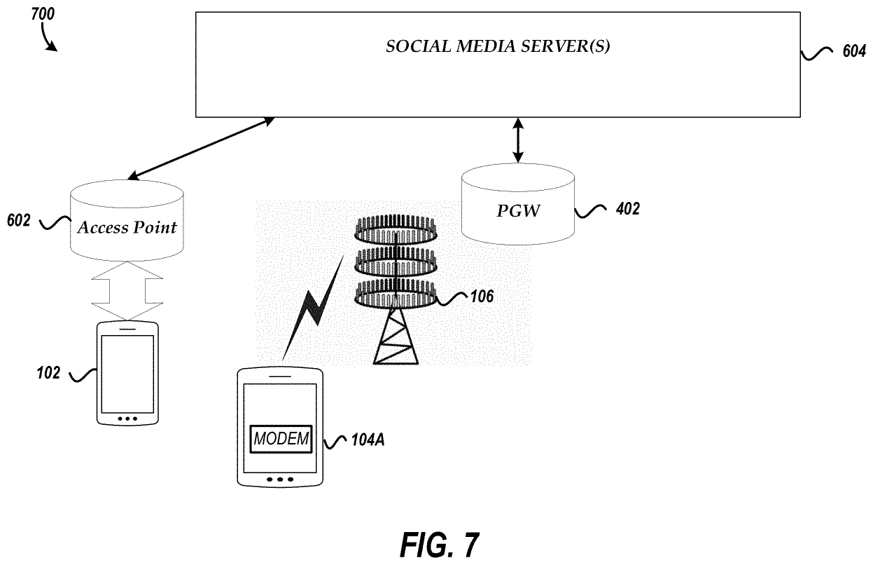

FIG. 7 is a diagram illustrating a communication environment 700 in which a social network list can be used to discover a UE for P2P communication. In the illustrated communication environment 700, there are no anchor UEs configured to connect to the social media server(s) 604 via a wireless access point. The illustrated anchor UE 104A is arranged to connect to the social media server(s) 604 via the base station 106. Accordingly, in some instances, anchor UEs in a wireless communication environment can only connect with the social media server(s) 604 via a base station. The illustrated elements in FIG. 7 can implemented in accordance with any suitable principles and advantages disclosed with reference to FIG. 6.

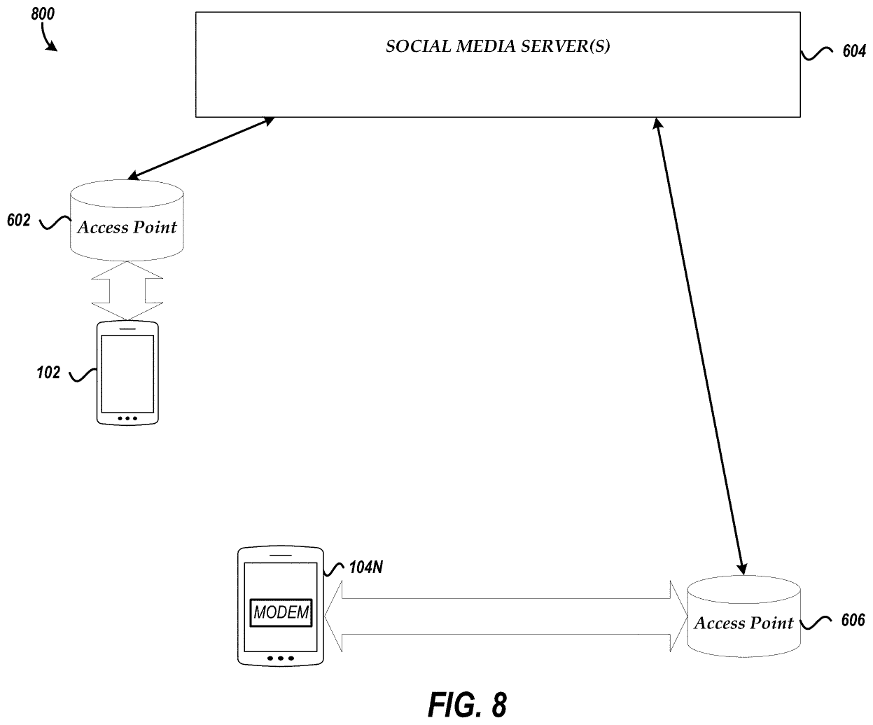

FIG. 8 is a diagram illustrating a communication environment 800 in which a social network list can be used to discover a UE for P2P communication. In the illustrated communication environment 800, there are no anchor UEs configured to connect to the social media server(s) 604 via a base station. The illustrated anchor UE 104N is arranged to connect to the social media server(s) 604 via the access point 606. Accordingly, in some instances, anchor UEs in a wireless communication environment can only connect with the social media server(s) 604 outside of a cellular carrier network, such as via a WiFi access point. The illustrated elements in FIG. 7 can implemented in accordance with any suitable principles and advantages disclosed with reference to FIG. 6.

FIG. 9 is a diagram illustrating a communication environment 900 in which a social network list can be used to discover a UE for P2P communication. In the illustrated communication environment 900, the primary wireless communication device 102 is not connected to the social media server(s) 604. The illustrated anchor UE 104N is arranged to connect to the social media server(s) 604 via the access point 606. The anchor UEs 104A and 104N can initiate a P2P connection with the primary wireless communication device 102 based on a social network list, for example, in accordance with any suitable principles and advantages disclosed with reference to FIG. 6. The social media server(s) 604 can initiate a P2P link between the primary wireless communication device 102 and an anchor UE 104A or 104N, for example, in accordance with any suitable principles and advantages disclosed with reference to FIG. 6.

Discovery of another UE with which to establish a P2P connection based on a social network list can be performed without user input in embodiments described herein. According to some applications, a primary wireless communication device can automatically request a P2P connection with a UE associated with a social network list. Alternatively or additionally, an anchor UE can have a default of accepting a P2P request with some or all UEs associated with a social network list.

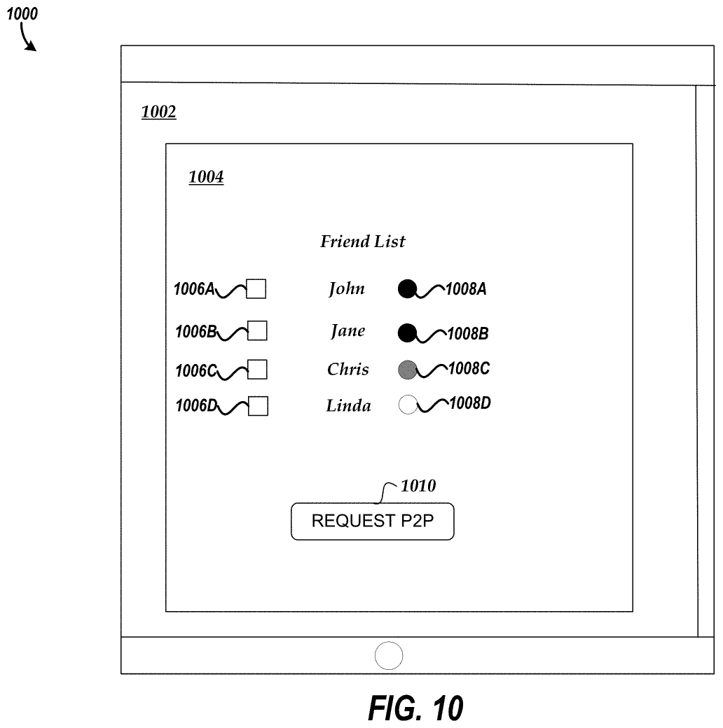

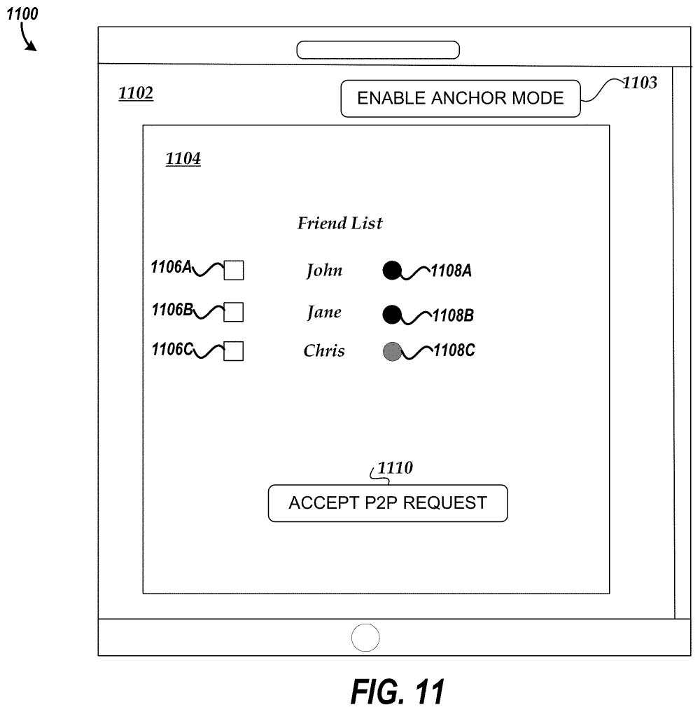

In certain applications, a user of a primary wireless communication device can provide input to discover another UE for forming a P2P connection and/or request the P2P connection. Alternatively or additionally, a user of an anchor UE can provide input to enable the anchor UE to serve as an anchor device for a primary wireless communication device and/or to accept a request to establish a P2P connection with a primary wireless communication device. Example user interfaces associated with user input related to establishing a P2P connection between a primary wireless communication device and an anchor UE are shown in FIGS. 10 and 11.

FIG. 10 illustrates an example primary wireless communication device 1000 with a user interface 1002 presenting a tab 1004 for requesting a peer-to-peer connection with an anchor user equipment associated with a social network list. The primary wireless communication device 1000 can be implemented in accordance with any suitable principles and advantages of the primary wireless communication devices disclosed herein. For example, the primary wireless communication device 1000 can store cellular subscription information and not include a cellular modem. With the primary wireless communication device 1000, a user can provide input to establish a P2P connection with an anchor device. The primary wireless communication device 1000 can exchange information with a cellular carrier network via the P2P connection and the anchor device.

As illustrated, the tab 1004 can include a friend list that includes selection elements 1006A to 1006D and status indicators 1008A to 1008D and a submission element 1010. A social media client stored on memory of the primary wireless communication device 1000 can cause the tab 1004 to be presented and process user input received by the user interface 1002. The friend list can present a list of social media connections of the user of the primary wireless communication device 1000. The tab 1004 presents status indicators 1008A, 1008B, 1008C, and 1008D indicating the status of friends of the user of the primary wireless communication device 1000. In the illustrated tab 1004, status indicators 1008A and 1008A can indicate that John and Jane are active, status indicator 1008C can indicated that Chris is online but inactive, and tab 1008D can indicate that Linda is not online. The user can select, via one or more of the selection elements 1006A, 1006B, 1006C, and 1006D, a UE of a friend to request a P2P connection. The user can request a P2P connection with a UE of the selected friend via the submission element 1010.

FIG. 11 illustrates an example anchor user equipment 1100 with a user interface 1102 presenting a tab 1104 for accepting a peer-to-peer connection request from a primary wireless communication device associated with a social network list. The anchor UE 1100 can be implemented in accordance with any suitable principles and advantages of the anchor UEs disclosed herein. The anchor UE 1100 serve as an anchor device for a primary wireless communication device and enable the primary wireless communication device to exchange information with a cellular carrier network via the P2P connection and the anchor UE 1100.

As illustrated, the user interface 1102 includes an anchor mode element 1103. A user can enter or exit anchor mode using the anchor mode element 1103. As shown in FIG. 11, the tab 1104 can include a friend list that includes selection elements 1106A to 1106C and status indicators 1108A to 1108C and a submission element 1110. A social media client stored on memory of the primary wireless communication device 1000 can cause the anchor mode element 1103 and/or the tab 1104 to be presented and process user input received by the user interface 1102. The friend list can present a list of social media connections of the user of the anchor UE 1100. The tab 1104 presents status indicators 1108A, 1108B, and 1108C indicating the status of friends of the user of the anchor UE 1100. The tab 1104 can show friends that have requested a P2P connection with the anchor UE 1100. The user can select, via one or more of the selection elements 1106A, 1106B, and 1106C UE of a friend to accept a P2P connection request. The user can accept the P2P connection request of the selected friend via the submission element 1110. In certain applications, a similar tab can be presented to enable the user of the anchor UE 1100 to offer a P2P connection with a UE associated with a social network list.

### Tokens for Anchor User Equipment

A variety of wireless communication devices may not be able to connect to a cellular carrier network due to capabilities of such devices and/or conditions associated with such devices connecting to the cellular carrier network. Alternatively or additionally, the cellular carrier network may provide sub-optimal wireless connection services to certain wireless communications device. By connecting to the cellular carrier network via an anchor device, wireless communications between a wireless communication device and the cellular carrier network can be enabled and/or enhanced. For example, a wireless communication device without a cellular modem that stores cellular subscription information can connect with the cellular carrier network via an anchor device. As another example, a wireless communication device that connects to the cellular network via a direct cellular link and also via an anchor device can experience more reliable communications with the cellular carrier network and/or a higher data rate.

Serving as an anchor device through which another wireless communication device communicates with a cellular carrier network can drain battery life and/or otherwise impact use of the anchor device. Accordingly, anchor devices can be unutilized resources for providing cellular connection services if a sufficient reward is not provided for serving as an anchor device.

Aspects of this disclosure relate to managing wireless communication between a wireless communication device and a cellular carrier network by providing tokens to an anchor device for serving as an anchor between the wireless communication device and the cellular carrier network. Tracking usage as an anchor device and providing tokens for serving as the anchor device can enable more wireless communication devices to connect to a cellular carrier network and/or enhance cellular connection service. Accordingly, more wireless communication devices can have access to a cellular carrier network.

Tokens can be provided to an anchor user equipment to reward the anchor user equipment for serving as an anchor device for a primary wireless communication device. Tokens can be provided from a variety of different sources to reward the anchor device for assistance with connecting the primary device to a cellular carrier network and/or the Internet. A social media service can set policies related to tokens and/or enable negotiation of the exchange of tokens for services. An amount of tokens provided to the anchor device can be based on one or more of a variety of factors. The amounts of tokens discussed herein can include one or more tokens or a fraction of a token. One or more social media server(s) can implement one or more of accounting, distribution, or negotiation of tokens. Such server(s) can implement blockchain technology and/or other token based accounting. Tokens can help facilitate a wireless communication device without a cellular modem exchanging information with a cellular carrier network via an anchor device. Accordingly, any suitable features associated with tokens disclosed herein can be applied in association with any suitable wireless communication devices and/or UEs disclosed herein. Alternatively or additionally, any suitable features associated with tokens disclosed herein can be applied in association with any suitable features of using a social network list disclosed herein.

Although the following description may refer to anchor UEs for illustrative purposes, any suitable principles and advantages disclosed with reference to anchor UEs can be applied to any other suitable anchor devices. Similarly, although the following description may refer to certain primary wireless communication devices (e.g., primary wireless communication devices without a cellular modem) for illustrative purposes, any suitable principles and advantages disclosed with reference to such devices can be applied to any other suitable wireless communication devices.

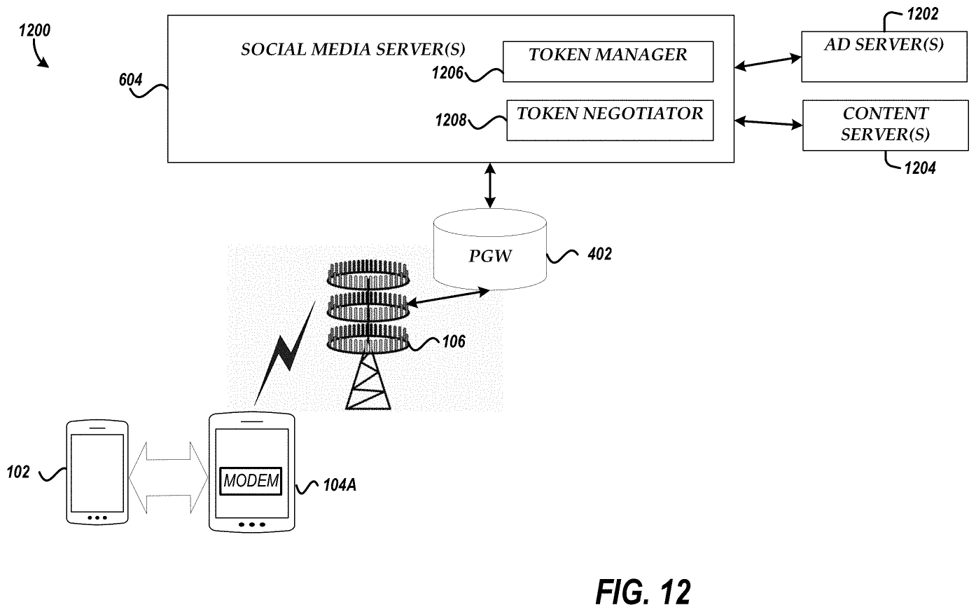

FIG. 12 is a diagram illustrating a communication environment 1200 in which a social media service can manage tokens associated with an anchor user equipment 104 serving as an anchor device for a primary wireless communication device 102. In the communication environment 1200, there are a number of ways that a social network service can manage tokens. One or more of these ways can be implemented in various applications. Social media server(s) 604 can be configured to execute blockchain and/or other token based accounting to keep track of tokens associated with users of the social media service and/or UEs associated with these users. Token management can incentivize anchor UEs to serve as anchor devices for other UEs. Accordingly, additional UEs can be served by a cellular carrier network with assistance of the anchor UEs.

As illustrated, the social media server(s) 604 can include a token management module 1206 and a token negotiation module 1208. The token management module 1206 can be stored in non-transitory computer readable memory of the social media server(s) 604 and be executed by one or more processors of the social media server(s) 604 to perform token management functionality. The token management module 1206 can generate tokens. The token management module 1206 can store tokens in a data structure, such as a table. The token management module 1206 can update accounts associated with anchor UEs for serving as an anchor device for a primary wireless communication device 102. The token management module 1206 can detect a P2P connection between a primary wireless communication device 102 and an anchor UE 104. The token management module 1206 can assign an amount of tokens to the anchor UE 104 based on the P2P connection. The P2P connection and the amount of tokens can be stored in a data structure, such as a table, by the token management module 1206. The token management module 1206 can perform any suitable token management functions disclosed herein.

The token negotiation module 1208 can be stored in non-transitory computer readable memory of the social media server(s) 604 and be executed by one or more processors of the social media server(s) 604 to perform token negotiation functionality. The token negotiation module 1208 can determine an amount of tokens to provide to an anchor UE based on one or more factors. The token negotiation module 1208 can match an amount of tokens that an anchor UE will accept for serving as an anchor device with an amount of tokens that are being offered for serving as an anchor device. Information from which to determine an amount of tokens for serving as an anchor device can be provided to the token negotiation module 1208. Based on this information, the token negotiation module 1208 can determine and/or assign an amount of tokens to provide an anchor UE for serving as an anchor UE. The token negotiation module 1208 can perform any suitable token negotiation functions disclosed herein.

The social media server(s) 604 can store account data for accounts associated with various UEs, and the account data can include a number of tokens in each respective account. The social media server(s) 604 can receive information and detect that an anchor UE serves as an anchor device for a primary wireless communication device. In response to detecting that a UE serves as an anchor device, the social media server(s) 604 can increase a number of tokens in the account for the UE. Tokens can be provided by various sources. In certain instances, tokens for an anchor UE can be provided by one or more of a social media service, a content provider, an advertiser, or a primary wireless communication device.

For example, the primary wireless communication device 102 can provide tokens to the anchor UE 104 for serving as an anchor device for the primary wireless communication device 102. A desired number of tokens can be added to an account associated with the primary wireless communication device 102. The primary wireless communication device 102 can provide information associated with providing tokens to the anchor UE 104 in association with requesting to establish a P2P link and/or with a request to exchange information with a cellular carrier network via the anchor UE 104. The social media server(s) 604 can manage the account of tokens and distribute the tokens to an account associated with the anchor UE 104 in association with the anchor UE 104 serving as an anchor device for the primary wireless communication device. The social media server(s) 604 can receive a request from the primary wireless communication device 102 to provide tokens to an account associated with the anchor UE 104. Such a request can be provided by the P2P link and the anchor UE 104. Alternatively or additionally, the request can be provided from the primary wireless communication device 102 to the social media server(s) 604 via a wireless access point.

In certain instances, advertising server(s) 1202 can provide tokens to the anchor UE 104 for serving as an anchor device for the primary wireless communication device 102. The advertising server(s) 1202 can provide tokens in exchange for advertisements being included in the data transmissions to the primary wireless communication device 102 via the anchor UE 104. The social media server(s) 604 can manage the accounting and distribution of tokens for including the advertisements in the data transmissions to the primary wireless communication device 102. By including advertisements in the data transmissions, the social media server(s) 604 can enable the primary wireless communication device 102 to communicate with a network via the anchor UE 104 without the primary wireless communication device 102 providing tokens to the anchor UE 104. In some instances, an account associated with the primary wireless communication device 102 can toggle a setting associated with allowing advertisements with data transmissions to the primary wireless communication device 102. The social media server(s) 604 can provide tokens from the advertising server(s) 1202 to an account associated with the anchor UE 104 for the anchor UE 104 serving as an anchor device that transmits data with the advertisements to the primary wireless communication device 102.

Content server(s) 1204 can provide tokens to the anchor UE 104 for serving as an anchor device for the primary wireless communication device 102 in certain applications. The content server(s) 1204 can sponsor certain content and provide tokens to the anchor UE 104 in exchange for the content being transmitted to the primary wireless communication device 102 via the anchor UE 104. The social media server(s) 604 can manage the accounting and distribution of tokens for transmitting the content to the primary wireless communication device 102. This can enable content providers to provide content to a primary wireless communication device 102 via an anchor UE 104 without the primary wireless communication device 102 providing tokens to the anchor UE 104. The social media server(s) 604 can provide tokens from the content server(s) 1204 to an account associated with the anchor UE 104 for the anchor UE 104 serving as an anchor device that transmits the content sponsored by the content server(s) to the primary wireless communication device 102.

The social media server(s) 604 can provide tokens to the anchor UE 104 for serving as an anchor device for the primary wireless communication device 102 in some applications. The social media server(s) 604 can provide tokens to the anchor UE 104 to enable the primary wireless communication device 102 to use a social media service and/or other services via the anchor UE 104. The social media server(s) 604 can provide tokens from the content server(s) 1204 to an account associated with the anchor UE 104 for the anchor UE 104 serving as an anchor device for the primary wireless communication device 102 in such instances.

The amount of tokens provided to the anchor UE 104 for serving as an anchor device can be pre-determined in certain applications. The amount of tokens provided to an anchor UE 104 for serving as an anchor UE 104 can be negotiated between the anchor UE 104 and one or more of the primary wireless communication device 102, the social media server(s) 604, the advertising server(s) 1202, or the content server(s) 1204 in various applications. The token negotiation module 1208 of the social media server(s) 604 can facilitate such negotiation.

For example, an account associated with the anchor UE 104 can set one or more preferences indicating a number of tokens that the anchor UE 104 will accept for serving as anchor device in one or more circumstances. Alternatively or additionally, a user of the anchor UE 104 can accept or deny a request for the anchor UE 104 to serve as an anchor device via providing input at a user interface. The token negotiation module 1208 of the social media server(s) 604 can match the preference(s) and/or user input of the account associated with the anchor UE 104 with the amount of tokens that are being offered to the anchor UE 104 for serving as an anchor device. In response to determining that a sufficient number of tokens are being offered to the anchor UE 104, the social media server(s) 604 can provide an indication to the anchor UE 104. The anchor UE 104 can enter an anchor mode to serve as an anchor device for the primary wireless communication device 102 in response to receiving the indication.

In certain instances, the amount of tokens provided to the anchor UE 104 for serving as an anchor device can vary based on a variety of factors. Example factors are discussed herein. An amount of tokens provided to the anchor UE 104 can be based on one or more of these factors. The amount of tokens can be determined by the token negotiation module 1208 of the social media server(s) 604.

An amount of tokens provided to the anchor UE 104 for serving as an anchor device can be based on the type of data being exchanged by the anchor UE 104. For example, the social media server(s) 604 can provide the anchor UE 104 more tokens for serving as an anchor device for streaming video content compared to for serving as an anchor device for a cellular phone call. More tokens can be provided for serving as an anchor device for more important data than for less important data. More tokens can be provided for serving as an anchor device that provides data that drains a battery of the anchor device more than other data.

An amount of tokens provided to the anchor UE 104 for serving as an anchor device can be based on a connection associated with the anchor UE 104. For example, the social media server(s) 604 can provide a different amount of tokens based on a type of P2P link between the primary wireless communication device 102 and the anchor UE 104 (e.g., WiFi and Bluetooth P2P links can be associated with different numbers of tokens). As another example, the social media server(s) 604 can provide a different amount of tokens based on link quality associated with the anchor UE 104. More tokens can be provided for anchor devices with higher link qualities. More tokens can be provided for serving as an anchor device with a higher quality of service than for a lower quality of service.

An amount of tokens provided to the anchor UE 104 for serving as an anchor device can be based on a social media connection associated with a user of the primary wireless communication device 102. For example, the social media server(s) 604 can provide the anchor UE 104 more tokens for serving as an anchor device for a primary wireless communication device 102 associated with a second level social media connection compared to another primary wireless communication device 102 associated with a first level social media connection.

An amount of tokens provided to the anchor UE 104 for serving as an anchor device can be based on network conditions. For example, the social media server(s) 604 can provide an amount of tokens based on a ratio of primary wireless communication devices to available anchor UEs. As another example, the social media server(s) 604 can provide an amount of tokens based on network loading. More tokens can be provided for serving as an anchor device when there is a higher load of the network and/or a greater demand for anchor devices

The social media server(s) 604 are arranged to provide tokens to accounts associated with anchor UEs. Accordingly, this can reward the anchor UEs for enabling any of the primary wireless communication devices disclosed herein to exchange information with a cellular carrier network via an anchor UE. Tokens can be provided to an account associated with an anchor UE serving as an anchor device for a variety of primary wireless communication devices, including primary wireless communication devices without a cellular modem and primary UEs that include a cellular modem. Tokens can be provided to an account associated with an anchor UE serving as an anchor device to enable the primary wireless communication device to connect with a cellular carrier network. Any suitable principles and advantages of tokens disclosed herein can be applied in applications in which an anchor UE serves as an anchor device to enable the primary wireless communication device to connect with a wireless access point, another UE, or the like.

In the communication environment 1200 of FIG. 12, social media server(s) 604 are arranged to manage tokens associated with an anchor user equipment 104 serving as an anchor device for a primary wireless communication device 102. In certain applications, any other suitable server(s) can be implemented with blockchain technology and/or token based accounting to manage tokens in accordance with any suitable principles and advantages disclosed herein.

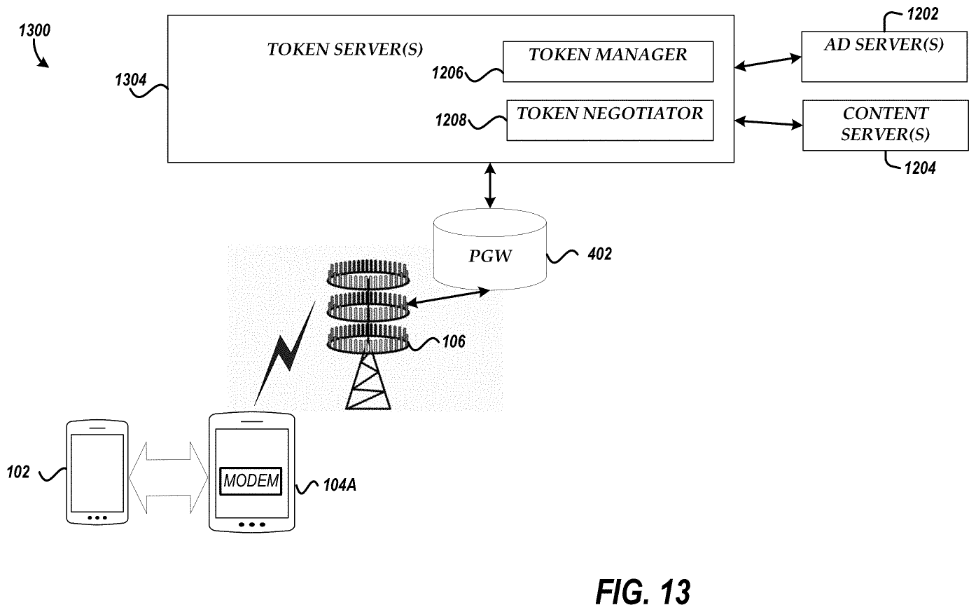

FIG. 13 is a diagram illustrating a communication environment 1300 in which one or more token servers can manage tokens associated with an anchor user equipment 104 serving as an anchor device for a primary wireless communication device 102. In the communication environment 1300, the one or more token servers 1304 can perform any suitable combination of features of the social media server(s) 604 associated with tokens. The one or more token servers 1304 can be implemented external to a cellular carrier network. For example, the one or more token servers 1304 can include one or more Internet Protocol (IP) servers. In some instances, the one or more token servers 1304 can be implemented as part of a cellular carrier network. For example, the one or more token servers 1304 can include a Policy and Charging Rules Function (PCRF) server. As another example, the one or more token servers 1304 can include an authentication, authorization, and accounting (AAA) server.

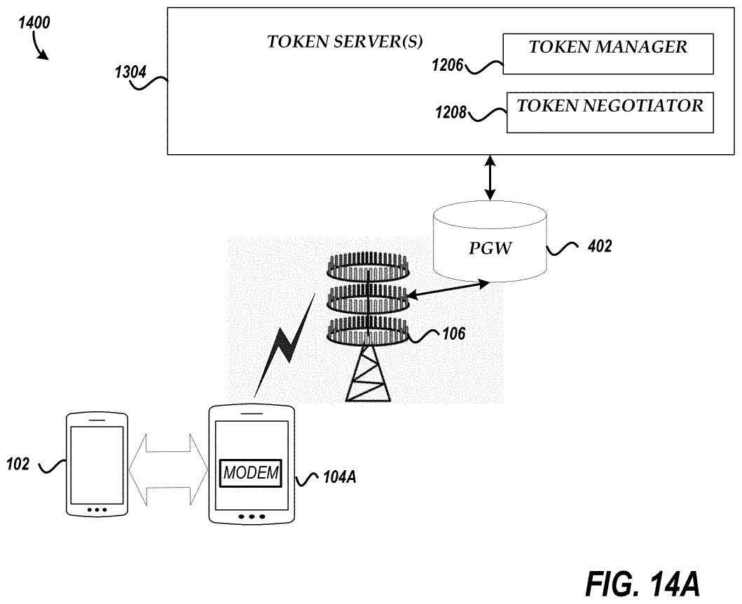

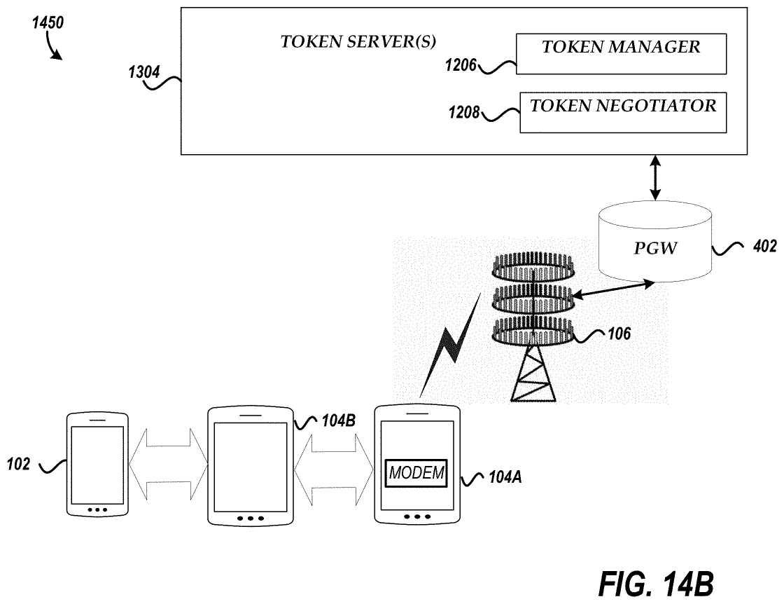

In some instances, one or more token servers can be implemented without connections to advertising server(s) and/or without connections to content server(s). FIG. 14A is a diagram illustrating a communication environment 1400 in which one or more token servers 1304 can manage tokens associated with an anchor user equipment 104 serving as an anchor device for a primary wireless communication device 102 where the one or more token servers 1304 are not connected to an advertising server or a content server.

FIG. 14B is a diagram illustrating a communication environment 1450 in which one or more token servers 1304 can manage tokens associated with an anchor user equipment serving as an anchor device for a primary wireless communication device 102 in a multi-hop case according to an embodiment. The primary wireless communication device 102 can wirelessly communicate with an intermediate anchor device 104B via a non-cellular link. The intermediate anchor device 104B can wirelessly communicate with the anchor device 104A via a non-cellular link in certain instances. The intermediate anchor device 104B can wirelessly communicate with the anchor device 104A via a cellular link in some other instances. The intermediate anchor device 104B can include a cellular modem in some instances. Although one intermediate anchor device 104B is shown in FIG. 14B, two or more intermediate anchor devices with links in serial and/or parallel can exchange information between the primary wireless communication device 102 and the anchor device 104A.

Any suitable principles and advantages disclosed herein related to tokens for an anchor device can be applied to an intermediate anchor device 104B. The one or more token servers 1304 can manage tokens for an anchor device 104A and/or one or more intermediate anchor devices 104B through which a primary wireless communication device 102 communicates with a cellular carrier network. The intermediate anchor device 104B can receive a different number of tokens than the anchor device 104A for serving as an anchor device. Alternatively, the intermediate anchor device 104B can receive the same number of tokens as the anchor device 104A for serving as an anchor device.

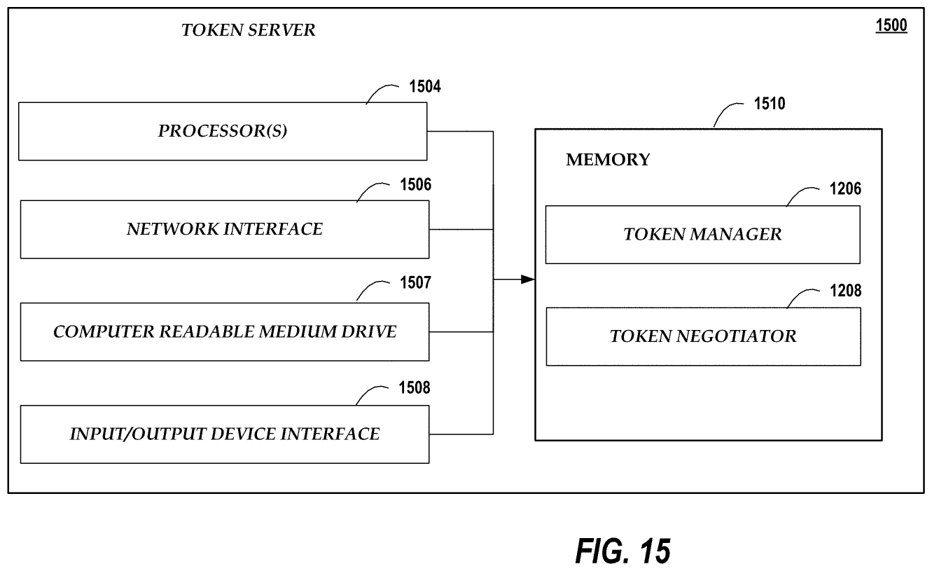

FIG. 15 is a block diagram of a token server 1500. The token server 1500 is an example of the one or more token servers 1304 of FIGS. 13 and 14. The token server 1500 also shows an example of a portion of the social media server(s) 604 with token management and token negotiation functionality. The general architecture of the token server 1500 shown in FIG. 15 includes an arrangement of computer hardware and software components that may be used to implement aspects of the present disclosure. The token server 1500 may include more components than shown in FIG. 15 and/or a subset of the illustrated components. As illustrated, the shown in FIG. 15 includes one or more processors 1504, a network interface 1506, a computer readable medium drive 1507, an input/output device interface 1508, and a memory 1510, all of which may communicate with one another by way of a communication bus. The network interface 1506 may provide connectivity to one or more networks or computing systems. The one or more processors 1504 can accordingly receive information and instructions from other computing systems or services via a network. The one or more processors 1504 can also communicate with the memory 1510. The one or more processors 1504 can receive input information and/or provide output information via the input/output device interface 1508.

The memory 1510 can store include non-transitory computer-executable instructions that the one or more processors 1504 execute in order to implement one or more embodiments. The memory 1510 can suitable non-transitory memory. The memory 1510 can store a token management module 1206. The memory 1510 can store a token negotiation module 1208. The one or more processors 1504 include any suitable physical hardware to execute the computer-executable instructions stored in the memory, such as instructions of the token management module 1206 and/or the token negotiation module 1208.

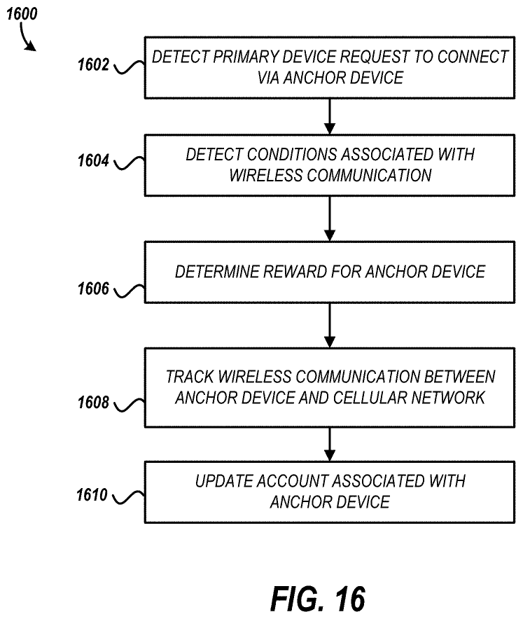

FIG. 16 is a flow diagram of an example method 1600 of wireless communication between a cellular carrier network and a wireless communication device according to an embodiment. The operations of the method 1600 can be performed in any order as appropriate. The method 1600 can be performed by any suitable server(s) disclosed herein, such as the social media server(s) 604 and/or the one or more token servers 1304 and/or the token server 1500. Generation and accounting of tokens can involve blockchain and/or other token based accounting technologies. Any suitable principles and advantages associated with managing tokens for anchor devices disclosed herein can be implemented in association with the method 1600. The method 1600 relates to operations of one or more servers providing tokens to provide a reward for a device for serving as an anchor device. This can enable a cellular carrier network to communication with certain wireless communication devices and/or enhance coverage using anchor devices that otherwise would not serve as anchor devices.

A request from a wireless communication device to connect to a network via an anchor device can be detected at block 1602. The wireless communication device can store cellular subscription information and not include a cellular modem. One or more servers can detect the request and that the wireless communication device does not include a modem and stores cellular subscription information in certain instances. The request can be to connect to a cellular carrier network via a cellular link between an anchor device and the cellular carrier network

At block 1604, one conditions association with wireless communication can be detected. Such conditions can include any conditions disclosed herein. Detecting one or more conditions can include identifying a type of data being exchanged between the wireless communication device and the cellular carrier network. Detecting one or more conditions can include identifying one or more network conditions, such as conditions related to link quality, network traffic, number of available anchor devices, number of devices requesting connection via anchor devices, ratio of anchor devices to devices requesting connection via anchor devices, the like, or any suitable combination thereof. Detecting one or more conditions can include identifying one or more characteristics of the anchor device, such a device type, battery life, device usage, link quality, number of antenna, application(s) installed and/or executing, whether the device is associated with a social network connection of a user of a requesting device, the like, or any suitable combination thereof.

An amount of tokens for serving as anchor device can be determined at block 1606. This can provide a reward for the anchor device wirelessly exchanging information associated with the wireless communication device with the cellular carrier network. The amount of tokens can be determined based on the one or more conditions detected at block 1606. The amount of tokens can be determined based on any other suitable factor or factors disclosed herein. The amount of tokens can be determined as a fixed amount for serving as an anchor device. The amount of tokens can be determined as a rate for an amount of time for serving as an anchor device and/or an amount of data exchanged by the anchor device.

Wireless communication of information associated with the wireless communication device between the anchor device and the cellular carrier network can be tracked at block 1608. This can involve receiving information from the anchor device and/or the cellular carrier network. The tracking can verify service as an anchor device and/or provide information associated with an amount of time served as an anchor device and/or an amount of data transferred by the anchor device.

At block 1610, account data for an account associated with the anchor device can be updated to increase a number of tokens for the account. This can reward the anchor device for functioning as an anchor for wireless communication between the wireless communication device and the cellular carrier network. In association with the updating, a number of tokens of an account associated with a content provider can be decreased. In association with the updating, a number of tokens of an account associated with an advertiser can be decreased. In association with the updating, a number of tokens of an account associated with the wireless communication device can be decreased.

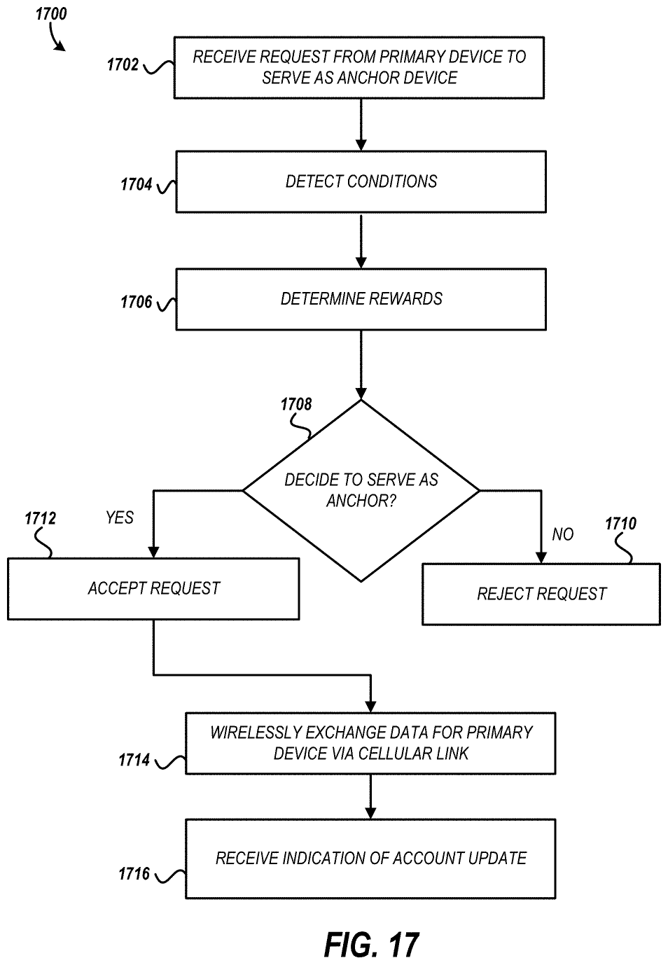

FIG. 17 is a flow diagram of an example method 1700 of facilitating wireless communication between a wireless communication device and a cellular carrier network according to an embodiment. The operations of the method 1700 can be performed in any order as appropriate. The method 1700 can be performed by any suitable anchor device disclosed herein, such as an anchor UE. Any suitable principles and advantages associated with serving as an anchor device disclosed herein can be implemented in association with the method 1700. The method 1700 relates to operations of a device determining whether to serve as an anchor device and, under the right conditions, serving as an anchor device.

At block 1702, an anchor device can receive a request to serve as an anchor device. The request can be from a wireless communication device via a non-cellular link. The wireless communication device can store cellular subscription information and not include a cellular modem.

The anchor device can detect one or more conditions at block 1704. The one or more conditions can include battery life, device usage, whether the wireless communication device is associated with a social media contact, link quality, the like, or any suitable combination thereof. The anchor device can determine a desired amount of tokens as a reward for serving as an anchor device at block 1706.

The anchor device can determine whether to serve as an anchor device as block 1708. This determination can be based on the one or more conditions detected at block 1704 and/or the amount of rewards being offered for serving as an anchor device. For example, when the anchor device is low on battery life, the anchor device can determine to deny a request to serve as an anchor. As another example, the anchor device can determine to deny a request to serve as an anchor base on a sufficient amount of tokens being offered and having a low device usage. In some instances, the determination can be based on whether the request is associated with a social media connection. If the anchor device decides not a serve as an anchor the request can be denied at block 1710. On the other hand, if the anchor device decides to serve as an anchor, the request can be grant at block 1712.

After granting the request, the anchor device can wireless exchange data for a wireless communication device with a cellular carrier network via a cellular link at block 1714. A cellular modem of the anchor user device can modulate data associated with the wireless communication device to generate modulated data associated with the wireless communication device. Such data can be wirelessly transmitted, by the anchor device, to the cellular carrier network via the cellular link. Similarly, data received from the cellular carrier network can be demodulated by the modem of the anchor device and then provided to the wireless communication device via a non-cellular link.

At block 1716, the anchor device can receive an indication that an account associated with the anchor device has been updated to increase an amount of tokens for serving as an anchor device.

### TERMINOLOGY, APPLICATIONS, AND CONCLUSION

Depending on the embodiment, certain acts, events, or functions of any of the processes or algorithms described herein can be performed in a different sequence, can be added, merged, or left out altogether (e.g., not all described operations or events are necessary for the practice of the process or algorithm). Moreover, in certain embodiments, operations, or events can be performed concurrently, e.g., through multi-threaded processing, interrupt processing, or multiple processors or processor cores or on other parallel architectures, rather than sequentially.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without other input or prompting, whether these features, elements, and/or steps are included or are to be performed in any particular embodiment. The terms “comprising,” “including,” and the like are synonymous and are used inclusively, in an open-ended fashion, and do not exclude additional elements, features, acts, operations, and so forth. Additionally, the words “herein,” “above,” “below,” and words of similar import, when used in this application, shall refer to this application as a whole and not to any particular portions of this application. Where the context permits, words in the above Detailed Description of Certain Embodiments using the singular or plural may also include the plural or singular, respectively. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated or generally understood from context, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

The word “coupled,” as generally used herein, refers to two or more elements that may be either directly coupled to each other, or coupled by way of one or more intermediate elements. Likewise, the word “connected,” as generally used herein, refers to two or more elements that may be either directly connected, or connected by way of one or more intermediate elements.

As used herein, the terms “determine” or “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. Also, “determining” may include resolving, selecting, choosing, establishing, and the like via a hardware element without user intervention.

As used herein, the terms “provide” or “providing” encompass a wide variety of actions. For example, “providing” may include storing a value in a location of a storage device for subsequent retrieval, transmitting a value directly to the recipient via at least one wired or wireless communication medium, transmitting or storing a reference to a value, and the like. “Providing” may also include encoding, decoding, encrypting, decrypting, validating, verifying, and the like via a hardware element.

While the above detailed description has shown, described, and pointed out novel features as applied to various embodiments, it can be understood that various omissions, substitutions, and changes in the form and details of the devices or algorithms illustrated can be made without departing from the spirit of the disclosure. For example, circuit blocks and/or method blocks described herein may be deleted, moved, added, subdivided, combined, arranged in a different order, and/or modified. Each of these blocks may be implemented in a variety of different ways. Any portion of any of the methods disclosed herein can be performed in association with specific instructions stored on a non-transitory computer readable storage medium being executed by one or more processors. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A method of managing wireless communication between a cellular carrier network and a wireless communication device, the method comprising:
detecting, by one or more servers, that the wireless communication device requests to connect to the cellular carrier network via a non-cellular link with an anchor device and a cellular link between the anchor device and the cellular carrier network, wherein the wireless communication device stores cellular subscription information for the cellular carrier network and does not include any cellular modem;
determining, by the one or more servers, an amount of tokens to provide to the anchor device for wirelessly exchanging information associated with the wireless communication device with the cellular carrier network;
tracking wireless communication of information associated with the wireless communication device between the anchor device and the cellular carrier network; and
in response to the determining and the tracking, updating, by the one or more servers, account data for an account associated with the anchor device to increase a number of tokens for the account.

2. The method of claim 1, wherein the method involves using blockchain technology.

3. The method of claim 1, further comprising determining that the wireless communication device does not include any cellular modem and stores the cellular subscription information.

4. The method of claim 1, wherein the one or more servers include a social media server associated with a social media service.

5. The method of claim 1, further comprising identifying a type of data being exchanged between the wireless communication device and the cellular carrier network, wherein the amount of tokens associated with the determining is based on the identifying.

6. The method of claim 1, further comprising identifying one or more network conditions, wherein the amount of tokens associated with the determining is based on the identifying.

7. The method of claim 1, wherein the updating comprises providing at least a portion of a token from a social media service to the account for the anchor device.

8. The method of claim 1, further comprising decreasing a number of tokens of an account associated with a content provider in association with the updating.

9. The method of claim 1, further comprising decreasing a number of tokens of an account associated with an advertiser in association with the updating.

10. The method of claim 1, further comprising decreasing a number of tokens of an account associated with the wireless communication device in association with the updating.

11. A system for managing wireless communication between a cellular carrier network and a wireless communication device, the system comprising:
one or more servers comprising one or more processors and memory storing computer-executable instructions, wherein the computer-executable instructions, when executed by the one or more processors, cause the one or more servers to at least:
detect that a wireless communication device requests to connect to a cellular carrier network via a non-cellular link with an anchor device and a cellular link between the anchor device and the cellular carrier network, wherein the wireless communication device stores cellular subscription information for the cellular carrier network and does not include any cellular modem;
determine an amount of tokens to provide to the anchor device for wirelessly exchanging information associated with the wireless communication device with the cellular carrier network;
track wireless communication of information associated with the wireless communication device between the anchor device and the cellular carrier network; and
update account data for an account associated with the anchor device to increase a number of tokens for the account based on the amount of tokens and the wireless communication of information associated with the wireless communication device between the anchor device and the cellular carrier network.

12. The system of claim 11, wherein the computer-executable instructions, when executed by the one or more processors, cause the one or more servers to determine that the wireless communication device does not include any cellular modem and stores the cellular subscription information.

13. The system of claim 11, wherein the one or more servers include a social media server associated with a social media service.

14. The system of claim 11, wherein the computer-executable instructions, when executed by the one or more processors, cause the one or more servers to determine the amount of tokens based on identifying a type of data being exchanged between the wireless communication device and the cellular carrier network.

15. The system of claim 11, wherein the computer-executable instructions, when executed by the one or more processors, cause the one or more servers to determine the amount of tokens based on identifying one or more network conditions.

16. A method of managing wireless communication between a cellular carrier network and a wireless communication device, the method comprising:
detecting, by one or more servers, that the wireless communication device requests to connect to the cellular carrier network via a cellular link between an anchor device and the cellular carrier network;
determining, by the one or more servers, an amount of tokens to provide to the anchor device for wirelessly exchanging information associated with the wireless communication device with the cellular carrier network;
tracking wireless communication of information associated with the wireless communication device between the anchor device and the cellular carrier network; and
in response to the determining and the tracking, updating, by the one or more servers, account data for an account associated with the anchor device to increase a number of tokens for the account.

17. The method of claim 16, wherein the method involves using blockchain technology.

18. The method of claim 16, wherein the tracking is associated with the wireless communication device communicating with the anchor device through a direct link between the anchor device and the wireless communication device.

19. The method of claim 16, wherein the tracking is associated with the wireless communication device communicating with the anchor device via an intermediate anchor device.

20. The method of claim 16, further comprising identifying a type of data being exchanged between the wireless communication device and the cellular carrier network, wherein the amount of tokens associated with the updating is based on the identifying.

21. The method of claim 16, further comprising identifying one or more network conditions, wherein the amount of tokens associated with the updating is based on the identifying.

22. The method of claim 16, further comprising identifying one or more characteristics of the anchor device, wherein the amount of tokens associated with the updating is based on the identifying.

23. The method of claim 16, further comprising identifying that the wireless communication device equipment does not include a cellular modem.
